(19) United States
(12) Patent Application Publication
(10) Pub. No.: US 2021/0042668 A1
(43) Pub. Date: Feb. 11, 2021

(54) Systems and Methods for Autonomous Vehicle Deployment and Control

(71) Applicant: UATC, LLC, San Francisco, CA (US)

(72) Inventors: Shenglong Gao, San Francisco, CA (US); Jay A. Chen, Fremont, CA (US); Konrad Julian Niemiec, Mountain View, CA (US)

(21) Appl. No.: 16/572,057

(22) Filed: Sep. 16, 2019

Related U.S. Application Data
(60) Provisional application No. 62/882,642, filed on Aug. 5, 2019.

(51) Int. Cl. G06Q 10/02; G06Q 30/02; G06Q 10/06; G07C 5/08; G07C 5/00; G06Q 50/30

(52) U.S. Cl. CPC G06Q 10/02; G06Q 30/0282; G06Q 50/30; G07C 5/0841; G07C 5/008; G06Q 10/06315

(57) ABSTRACT

Systems and methods for selecting, deploying, and controlling autonomous vehicles are provided. For example, a method can include obtaining data indicative of transportation service request and determining that a human driver would not prefer to service the transportation service request. The method can include determining an availability of a plurality of vehicle service providers for the transportation service request (e.g., human driven vehicles, autonomous vehicles). The method can include obtaining operational capability information associated with the autonomous vehicle(s). The method can include generating ranking data associated with the available vehicle service providers and determining at least one selected vehicle service provider for the transportation service request utilizing the ranking data. The method can include generating vehicle service assignment data associated with the service request and communicating the vehicle service assignment data to the at least one selected vehicle service provider to facilitate performance of the requested service.

### RELATED APPLICATION

This application claims priority to and the benefit of U.S. Provisional Patent Application No. 62/882,642, titled “Systems and Methods for Autonomous Vehicle Deployment and Control,” and filed on Aug. 5, 2019. U.S. Provisional Patent Application No. 62/882,642 is hereby incorporated by reference herein in its entirety.

### FIELD

The present disclosure relates generally to devices, systems, and methods for selecting autonomous vehicles for deployment and controlling autonomous vehicles.

### BACKGROUND

An autonomous vehicle can be capable of sensing its environment and navigating with little to no human input. In particular, an autonomous vehicle can observe its surrounding environment using a variety of sensors and can attempt to comprehend the environment by performing various processing techniques on data collected by the sensors. Given such knowledge, an autonomous vehicle can navigate through the environment.

### SUMMARY

Aspects and advantages of embodiments of the present disclosure will be set forth in part in the following description, or may be learned from the description, or may be learned through practice of the embodiments.

Other example aspects of the present disclosure are directed to systems, methods, vehicles, apparatuses, tangible, non-transitory computer-readable media, and memory devices for controlling autonomous vehicles.

One example aspect of the present disclosure is directed to a computer-implemented method, the method including obtaining data indicative of a transportation service request. The method further includes determining that a human driver would not prefer to service the transportation service request based at least in part on the data indicative of the transportation service request. The method further includes determining an availability of a plurality of vehicle service providers for the transportation service request, wherein the plurality of vehicle service providers includes one or more human driven vehicles and one or more autonomous vehicles. The method further includes obtaining operational capability information associated with the one or more autonomous vehicles. The method further includes generating ranking data associated with the available vehicle service providers based at least in part on the data indicative of the transportation service request, the operational capability information, and the determination that the human driver would not prefer to address the transportation service request, wherein the ranking data is indicative of a ranking of at least a subset of the available service providers for servicing the transportation service request. The method further includes determining at least one selected vehicle service provider for the transportation service request based at least in part on the ranking data. The method further includes generating vehicle service assignment data associated with performance of the transportation service request. The method further includes communicating the vehicle service assignment data to the at least one selected vehicle service provider to facilitate performance of a vehicle service associated with the transportation service request.

Another example aspect of the present disclosure is directed to a computing system including one or more processors and one or more memories including instructions that, when executed by the one or more processors, cause the one or more processors to perform operations. The operations include obtaining data indicative of a transportation service request. The operations further include determining whether a human driver would prefer to service the transportation request with a human driven vehicle based at least in part on the data indicative of the transportation service request. The operations further include determining an availability of a plurality of vehicle service providers for the transportation service request, wherein the plurality of vehicle service providers includes one or more human driven vehicles and one or more third party autonomous vehicles. The operations further include generating ranking data associated with the available vehicle service providers based at least in part on the data indicative of the transportation service request and the determination as to whether the human driver would prefer to service the transportation service request, wherein the ranking data is indicative of a ranking of at least a subset of the available service providers for servicing the transportation service request. The operations further include determining one or more selected vehicle service providers for the transportation service request based at least in part on the ranking data. The operations further include generating vehicle service assignment data associated with performance of the transportation service request. The operations further include communicating the vehicle service assignment data to the one or more selected vehicle service providers.

Yet another example aspect of the present disclosure is directed to one or more tangible, non-transitory computer-readable media storing computer-readable instructions that when executed by one or more processors cause the one or more processors to perform operations. The operations include obtaining data indicative of a transportation service request. The operations further include determining an availability of a plurality of vehicle service providers for the transportation service request. The operations further include generating ranking data for each of the available vehicle service providers based at least in part on the data indicative of the transportation service request and a rating associated with the transportation service request, the rating indicating whether a human driver would prefer to service the transportation service request with a human driven vehicle. The operations further include generating vehicle service assignment data associated with performance of a vehicle service associated with the transportation service request. The operations further include determining one or more selected vehicle service providers for the transportation service request based at least in part on the ranking data. The operations further include communicating the vehicle service assignment data to the one or more selected vehicle service providers.

The autonomous vehicle technology described herein can help improve the safety of passengers of an autonomous vehicle, improve the safety of the surroundings of the autonomous vehicle, improve the experience of the rider and/or operator of the autonomous vehicle, as well as provide other improvements as described herein. Moreover, the autonomous vehicle technology of the present disclosure can help improve the ability of an autonomous vehicle to effectively provide vehicle services to others and support the various members of the community in which the autonomous vehicle is operating, including persons with reduced mobility and/or persons that are underserved by other transportation options. Additionally, the autonomous vehicle of the present disclosure may reduce traffic congestion in communities as well as provide alternate forms of transportation that may provide environmental benefits.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example system for controlling the navigation of an autonomous vehicle according to example embodiments of the present disclosure.

FIG. 2 depicts an example infrastructure system according to example embodiments of the present disclosure.

FIG. 3 depicts an example of routing for a vehicle service according to example embodiments of the present disclosure.

FIG. 4 depicts an example data structure associated with a transportation service request according to example embodiments of the present disclosure.

FIG. 5 depicts example types of vehicle service providers according to example embodiments of the present disclosure.

FIG. 6 depicts an example of vehicle service provider ranking according to example embodiments of the present disclosure.

FIG. 7 depicts a flow diagram of an example method for performing allocation of vehicle service assignments according to example embodiments of the present disclosure.

FIG. 8 depicts example units associated with a computing system for performing operations and functions according to example embodiments of the present disclosure.

FIG. 9 depicts a block diagram of an example computing system according to example embodiments of the present disclosure.

### DETAILED DESCRIPTION

Example aspects of the present disclosure are directed to improved techniques for efficiently determining allocation of vehicle service assignments for a mix of different types of vehicle service providers, including human driven vehicles, autonomous vehicles associated with a service entity (e.g., service entity/first party autonomous vehicles), and/or autonomous vehicles associated with one or more third parties (e.g., third party autonomous vehicles). In particular, the systems and methods of the present disclosure provide for determining a rating for a transportation service request that indicates whether a human driver would prefer to service the transportation service request (a “human driver favorability rating”). As described herein, such rating can be used for determining the allocation of a vehicle service assignment associated with the transportation service request to one of a ranked set of available vehicle service providers. As an example, a user may submit a request for a transportation service to a service entity (e.g., via an application on a user device, etc.). The service entity can determine a human driver favorability rating based in part on parameters associated with the transportation service request, where the human driver favorability rating is indicative of the whether a human driver would prefer to service the transportation service request with a human driven vehicle. The service entity can determine a set of available vehicle service providers (e.g., one or more human driven vehicles, one or more first or third party autonomous vehicles, etc.) and generate ranking data for at least a subset of the available vehicle service providers, for example, based in part on this rating. The service entity can provide vehicle service assignment data (e.g., indicating the origin, destination, route, etc. associated with the transportation service request, etc.) to at least one of the available vehicle service providers based on the ranking data to facilitate performance of the vehicle service for the user. Thus, the systems and methods of the present disclosure provide for determining allocation of vehicle service assignments among a heterogeneous mix of vehicle service providers in a manner that provides benefits including improvements in service assignment efficiency and supply management, improvements in driver experience, and the like.

More particularly, an entity (e.g., service entity, owner, manager) can use one or more vehicles (e.g., ground-based vehicles) to provide a vehicle service such as a transportation service (e.g., rideshare service), a courier service, a delivery service, etc. The vehicle(s) can be autonomous vehicles that include various systems and devices configured to control the operation of the vehicle. For example, an autonomous vehicle can include an onboard vehicle computing system for operating the autonomous vehicle (e.g., located on or within the autonomous vehicle). The vehicle computing system can obtain sensor data from sensor(s) onboard the vehicle (e.g., cameras, LIDAR, RADAR), attempt to comprehend the vehicle's surrounding environment by performing various processing techniques on the sensor data, and generate an appropriate motion plan through the vehicle's surrounding environment. Moreover, an autonomous vehicle can be configured to communicate with one or more computing devices that are remote from the vehicle. For example, the autonomous vehicle can communicate with a remote computing system that can be associated with the entity, such as the entity's operations computing system. The operations computing system can include a plurality of system clients that can help the entity monitor, communicate with, manage, etc. autonomous vehicles. In this way, the entity can manage the autonomous vehicles to provide the vehicle services of the entity.

The autonomous vehicles utilized by the entity to provide the vehicle service can be associated with a fleet of the service entity or a third party. For example, the service entity may own, lease, etc. a fleet of autonomous vehicles that can be managed by the service entity (e.g., its backend system clients) to provide one or more vehicle services. An autonomous vehicle utilized to provide the vehicle service(s) can be included in this fleet of the entity. Such autonomous vehicle may be referred to as “service entity autonomous vehicles” or “first party autonomous vehicles.” In some implementations, an autonomous vehicle can be associated with a third party vehicle provider such as, for example, an individual, an original equipment manufacturer (OEM), a third party vendor, or another entity. These autonomous vehicles may be referred to as “third party autonomous vehicles.” Even though such an autonomous vehicle may not be included in the fleet of autonomous vehicles of the entity, the entity infrastructure can include a platform that can allow the autonomous vehicle(s) associated with a third party to still be utilized to provide the vehicle services offered by the service entity, access the service entity's system clients, and/or the like.

For example, the service entity infrastructure can include a platform including one or more application programming interfaces (APIs) that are configured to allow autonomous vehicles and/or server computing systems associated with one or more entities (e.g., service entity, third party vendors, etc.) and one or more service entity infrastructure endpoints (e.g., system clients, etc.) to efficiently communicate. Such components can facilitate secure, bidirectional communications between autonomous vehicles and/or server computing systems associated with a plurality of entities (e.g., clients) and a service entity infrastructure such as, for example, a service entity's operations system (e.g., including a data center).

In particular, in some implementations, a service entity infrastructure can include a vendor integration platform (VIP) that includes a public platform and a private platform to facilitate services between the service entity infrastructure and autonomous vehicles and/or server computing systems associated with one or more entities (e.g., associated with the service entity, associated with third party vendors, etc.). The public platform can facilitate access to service entity services by service entity autonomous vehicles and third party autonomous vehicles. The public platform can provide access to service entity services such as trip assignment services, routing services, supply positioning services, payment services and/or the like. The private platform can provide access to provider entity services that are specific to the service entity autonomous vehicle fleet such as fleet management services, remote autonomy assistance, and/or the like. In some implementations, communication via the VIP can be for purposes of coordinating implementation of one or more services (e.g., vehicle-based transportation services such as ride-share services, delivery services, courier services, etc.) across different parties, geographic locations, and/or the like. In an example of a vehicle-based transportation service, third-party clients can communicate with the VIP in addition to first-party clients (e.g., service entity clients) so that all such clients can accept service-related assignments managed by the service entity.

A service entity can provide vehicle services such as a transportation services (e.g., rideshare service), courier services, delivery services, and/or the like based, for example, on vehicle service requests (e.g., transportation service requests, etc.) from users. For example, a user may execute an application associated with the service entity on a user device (e.g., smart phone, tablet, wearable device, other computing device, etc.) through which the user can request the service entity to facilitate performance of a vehicle service. The application can allow a user to communicate a transportation service request to the service entity (e.g., a computing system associated therewith). In some implementations, a transportation service request can include various data provided by and/or associated with the user such as, for example, an originating point and a destination for the vehicle service, timing of the vehicle service, routing preferences, number of passengers, user preferences, and/or the like. The service entity can generate transportation service assignment data based in part on the transportation service request to facilitate performance of the vehicle service by an available vehicle service provider (e.g., a human driven vehicle associated with the service entity, first party autonomous vehicle, a third party autonomous vehicle, etc.). In some implementations, the transportation service assignment data can include various data such as the service origin and destination, actions to be performed, way points, and/or the like. The service entity can communicate an offer for a service assignment (e.g., including the transportation service assignment data) to one or more available vehicle service providers and receive an acceptance to perform the vehicle service from one of the available vehicle service providers. The service entity can confirm acceptance of the vehicle service performance and facilitate initiation of the requested transportation service for the user.

According to an aspect of the present disclosure, a rating can be determined for a transportation service request. The rating can be indicative of whether a human driver would prefer to service the transportation service request with a human-driven vehicle (“a human driver favorability rating”). This can indicate the favorability of servicing the transportation service request for a human driven vehicle (e.g., the value, incentives, etc. for a human driven vehicle to perform the service(s)). This rating can be used in determining ranking data associated with available vehicle service providers (e.g., one or more human driven vehicles, one or more service entity autonomous vehicles, one or more third party vendor autonomous vehicles, etc.). For example, a service entity (e.g., operations computing system, etc.) can determine the rating based in part on parameters associated with the transportation service request that may be indicative of the favorability to a human driver. In some implementations, the rating can be based at least in part on one or more factors such as a route associated with the transportation service request, a projected travel time associated with the transportation service request, a destination associated with the transportation service request, and/or the like. For example, the type of a route may be less favorable to a human driven vehicle than an autonomous vehicle, such as short routes, dead heading routes (e.g., where a return service assignment is unlikely to be available within a specified/threshold distance of a service destination), and/or the like. In some implementations, the rating can be based at least in part on one or more factors such as one or more wait times associated with a transportation service request. For instance, a transportation service request may be less favorable to a human driven vehicle based on projected wait time(s) for the proposed route associated with the transportation service request, for example, associated with current and/or projected traffic, road construction, events, and/or the like along the proposed route. In some implementations, the rating can be based at least in part on one or more factors such as one or more area risk profiles associated with a route to be traveled for a transportation service request. For instance, risk profiles may be associated with (e.g., obtained, stored, etc.) one or more areas within a geographic region where vehicle services are provided. The risk profile for an area may be indicative of the risk to a human driven vehicle in the area (e.g., areas where it may be dangerous for a driver carrying a large amount of currency, high crime rate, etc.), the risk to an autonomous vehicle (e.g., areas where an autonomous vehicle operation may not be safe, more susceptible to damage, etc.) and or the like. In some implementations, the rating can be based at least in part on one or more factors such as a profile associated with a user associated with a transportation service request. For example, a user profile associated with the user requesting the transportation service request may be indicative of a user's experience with and/or favorability with one or more types of autonomous vehicles (e.g., one or more types of service provider autonomous vehicles, one or more types of third party autonomous vehicles, etc.), a user's preference for a human driven vehicle, and/or the like.

According to another aspect of the present disclosure, ranking data can be determined for one or more available vehicle service providers and the ranking data can be used in part to select a vehicle service provider for performance of a transportation service request. For example, in some implementations, a service entity (e.g., operations computing system, etc.) can determine available vehicle service providers (e.g., one or more human driven vehicles, one or more service entity autonomous vehicles, one or more third party vendor autonomous vehicles, etc.) and generate ranking data associated with at least some of the available vehicle service providers. In some implementations, the available vehicle service providers can include vehicle service providers (e.g., one or more human driven vehicles, one or more service entity autonomous vehicles, one or more third party vendor autonomous vehicles, etc.) that are currently online/active in a service entity provider system (e.g., actively engaged, logged in, etc. to a service entity platform, etc.) and are not currently engaged in performance of a vehicle service, performance of a maintenance operation, and/or the like. The ranking data associated with one or more of the available vehicle service providers can be generated based at least in part on data associated with the transportation service request, the rating associated with the transportation service request, and/or the like. In some implementations, the ranking data may be indicative of a ranking (e.g., list, hierarchy, tree, table, and/or other data structure) of at least a subset of the available vehicle service providers in order of highest to lowest preference for servicing the transportation service request. In some implementations, the ranking data may be indicative of a priority for selecting a respective vehicle service provider for performance of the transportation service request where the priority for selecting one or more autonomous vehicles is inversely proportional to the rating such that the priority associated with the one or more autonomous vehicles is higher for a lower rating. For example, if a transportation service request receives a lower rating (e.g., due to one or more factors as described), the priority for assigning an autonomous vehicle to perform the transportation service request (e.g., the ranking for available autonomous vehicles) will be higher than the priority for assigning a human driven vehicle to the request. Further, in some implementations, as the rating gets lower, the priority for assigning an autonomous vehicle to perform the request gets respectively higher.

According to another aspect of the present disclosure, in some implementations, generating ranking data associated with one or more available vehicle service providers may be based at least in part on operational capability information associated with autonomous vehicle(s) (e.g., service entity autonomous vehicle, third party autonomous vehicles, etc.). The operational capability information may be indicative of the types of autonomous vehicle capabilities (e.g., left turn capability, U-turn capability, autonomous motion functions, etc.) and/or operating conditions, routes, and/or the like where one or more autonomous vehicles (e.g., service entity autonomous vehicles, third party vendor autonomous vehicles, etc.) can operate. In some implementations, a priority for each of the respective third party autonomous vehicles to service a transportation service request can be generated based at least in part on the respective operational capability information of each of the third party autonomous vehicles. In some implementations, a determination can be made regarding whether one or more of the third party autonomous vehicles are capable of servicing a transportation service request based at least in part on operational capability information associated with the one or more third party autonomous vehicles, and if the third party autonomous vehicle(s) are not capable of servicing the transportation service request, the third party autonomous vehicle(s) that are not capable of servicing the transportation service request can be omitted from the ranking data. By way of example, a transportation service that would require a left turn or U-turn may not be appropriate for a third party autonomous vehicle that is unable to autonomously perform such a motion function.

In some implementations, generating ranking data associated with one or more available vehicle service providers may be based in part on historical acceptance rates associated with vehicle service providers for particular routes and/or types of vehicle services. For example, a service entity provider may monitor and/or store data associated with the acceptances or rejections of routes and/or services made by one or more vehicle service providers (e.g., human driven vehicles, autonomous vehicles, etc.). The service entity may use the data to determine acceptance rates for particular routes for a particular vehicle service provider and use the acceptance rates in generating ranking data for a particular vehicle service provider in association with a transportation service request. By way of example, if a vehicle service provider has a historically lower acceptance rate for vehicle services associated with particular routes, this lower acceptance rate may cause the vehicle service provider to be ranked low in the ranking data when those routes are associated with a transportation service request. On the other hand, if a vehicle service provider has a historically high acceptance rate for vehicle services associated with particular routes, this high acceptance rate may cause the vehicle service provider to be ranked higher in the ranking data when those routes are associated with a transportation service request.

In some implementations, generating ranking data associated with one or more available vehicle service providers may be based in part on historical performance data associated with performance of vehicle services and/or routes by a vehicle service provider. For example, a service entity provider may monitor and/or store data associated with the performance of vehicle services by one or more vehicle service providers (e.g., third party autonomous vehicles, etc.). The service entity provider may use the historical performance data in generating ranking data for a particular vehicle service provider in association with a transportation service request. In some implementations, the historical performance data may be used in determining particular types of routes, route segments, and/or the like that have been problematic for a particular vehicle service provider (e.g., third party autonomous vehicles, etc.). By way of example, historical performance data may indicate that a vehicle service provider has had difficulties in performing vehicle services appropriately and/or efficiently for certain types of routes, route segments, route requirements (e.g., left turns, U-turns, etc.), and/or the like. Such historical performance data indicative of problematic routes, route segments, route requirements, etc. for the vehicle service provider may cause the vehicle service provider to be ranked low in the ranking data when those types of routes, route segments, route requirements, etc. are associated with a transportation service request.

In some implementations, the ranking data for vehicle service providers may include a subset of the currently available vehicle service providers. For example, one or more available vehicle service providers may be excluded from the ranking data based on one or more factors indicative of an inability to perform the transportation service request, such as the operational capabilities of the vehicle service provider(s), the historical acceptance rates of the vehicle service provider(s), the historical performance data of the vehicle service provider(s), and/or the like. By way of example, a first available autonomous vehicle associated with a first fleet (e.g., service entity fleet, third party fleet, etc.) may be included in the ranking data for vehicle service providers for a transportation service request because the first available autonomous vehicle has one or more operational capabilities that align with the transportation service request (e.g., the autonomous vehicle can perform certain autonomous motion control that is needed to perform the transportation service request). On the other hand, a second available autonomous vehicle associated with a second fleet (e.g., service entity fleet, third party fleet, etc.) may be excluded from the ranking data for vehicle service providers for the transportation service request because the second available autonomous vehicle cannot perform certain autonomous motion control that may be needed to perform the transportation service request.

In some implementations, the systems and methods can provide for obtaining operational capability information associated with autonomous vehicles (e.g., service entity autonomous vehicle, third party autonomous vehicles, etc.) from one or more sources. For example, in some implementations, operational capability information for one or more autonomous vehicles may be provided by a third party vendor associated with the autonomous vehicle(s) (e.g., autonomous vehicles owned, managed, etc. by the third party vendor) and such operational capability information for the autonomous vehicle(s) may be stored (e.g., associated with particular autonomous vehicle(s)) by the service entity (e.g., in one or more databases associated with the service entity infrastructure, etc.) and retrieved as needed (e.g., for determining ranking of vehicle service providers, etc.). In some implementations, operational capability information for one or more autonomous vehicles may be generated based on historical tracking and/or observation of one or more autonomous vehicles associated with a particular fleet (e.g., one or more third party vendor fleets, etc.). Such generated operational capability information may be stored (e.g., associated with particular autonomous vehicle(s)) by the service entity (e.g., in one or more databases associated with the service entity infrastructure, etc.) and retrieved as needed (e.g., for determining ranking of vehicle service providers, etc.).

In some implementations, the systems and methods can provide for adjusting one or more rating and/or provider ranking costs, factors, and/or the like, for example, to modify the priorities for assigning vehicle service(s) to different types of vehicle service providers (e.g., human driven vehicles, service entity autonomous vehicles, third party vendor autonomous vehicles, etc.). For instance, a service entity may temporarily adjust ranking costs, factors, and/or the like to increase or decrease a preference for assigning particular vehicle services to one of the types of vehicle service providers, such as to adjust current vehicle supply, improve positive experience levels for drivers and/or third party vendors, and/or the like.

According to another aspect of the present disclosure, in some implementations, the systems and methods can provide for communicating vehicle service assignment data (e.g., associated with a transportation service request) to one or more selected vehicle service providers (e.g., human driven vehicles, service entity autonomous vehicles, third party vendor autonomous vehicles, etc.) and allow a selected vehicle service provider to accept or decline the performance of the vehicle service(s) associated with the transportation service request. As an example, a service entity (e.g., operations computing system, etc.) can communicate the vehicle service assignment data to the selected vehicle service provider(s) to facilitate an acceptance by a selected vehicle service provider before completing assignment of the transportation service request to the selected vehicle service provider. In some implementations, an indication of an acceptance and/or rejection to perform the service(s) can be obtained from a human driver associated with the human driven vehicle (e.g., via an application associated with the service entity, etc.), by a computing system associated with an autonomous vehicle (e.g., onboard an autonomous vehicle, etc.), by a computing system associated with a third party vendor (e.g., a third party vendor operations computing system, etc.), and/or the like. In some implementations, the data communicated in the initial vehicle service assignment data (e.g., offer for assignment data sent prior to receiving an acceptance and completing the assignment to the vehicle, etc.) may vary based on the type of vehicle service provider. For instance, in some implementations, the initial vehicle service assignment data provided to a human driven vehicle may include data that is not provided to an autonomous vehicle or vice versa.

In some implementations, the initial vehicle service assignment data (e.g., offer for assignment data sent prior to receiving an acceptance and completing the assignment to the vehicle, etc.) may be communicated to a first selected vehicle service provider (e.g., selected based on the ranking data associated with the vehicle service providers, etc.) to facilitate an indication of acceptance or rejection of performance of the vehicle service assignment. If the first selected vehicle provider rejects performance of the vehicle service assignment, the initial vehicle service assignment data may be communicated to a next selected vehicle service provider included in the ranking data, and so on, until performance of the vehicle service assignment is accepted by a vehicle service provider. In some implementations, the next selected vehicle service provider may be ranked lower than the first selected vehicle service provider in the ranking data. As an example, an autonomous vehicle may be a ranked higher within the ranking data than a human driven vehicle, based in part on the rating and/or the like (e.g., where performance of a vehicle service along a proposed route may be more favorable to performance by an autonomous vehicle than by a human driven vehicle). The service entity (e.g., operations computing system, etc.) may communicate the initial vehicle service assignment data to the autonomous vehicle (e.g., first selected vehicle service provider), however due to one or more factors, the autonomous vehicle may reject the vehicle service assignment. The service entity (e.g., operations computing system, etc.) may then communicate the initial vehicle service assignment data to a lower ranked human driven vehicle to ensure performance of the transportation service request, even though the vehicle service/route may be less favorable to a human driven vehicle.

According to another aspect of the present disclosure, in some implementations, the systems and methods can provide for communicating vehicle service assignment data (e.g., associated with a transportation service request) to multiple vehicle service providers concurrently to facilitate an acceptance to perform the service associated with a transportation service request. As an example, the vehicle service assignment data can be communicated (e.g., by a service entity) to multiple available vehicle service providers (e.g., human driven vehicles, service entity autonomous vehicles, third party vendor autonomous vehicles, etc.) based on ranking data associated with available vehicle service providers. The service entity (e.g., operations computing system, etc.) can receive an acceptance from one or more of the vehicle service providers indicating that the accepting service provider can perform the vehicle service(s) associated with the transportation service request. The service entity (e.g., operations computing system, etc.) can determine which of the accepting vehicle service providers will be assigned to perform the requested service(s), for example, based in part on the ranking data and/or one or more other factors. In some implementations, service entity may establish a time window for receiving an acceptance, to perform the service(s), from one or more of the available vehicle service providers after communicating the vehicle service assignment data to the one or more of the available vehicle service providers, where during the time window the service entity may establish a preference for one type of vehicle service provider over a different type of vehicle service provider. As an example, the service entity may establish a time window wherein an acceptance by a human driven vehicle during the time window will receive preference over an acceptance by an autonomous vehicle.

According to another aspect of the present disclosure, in some implementations, the systems and methods can provide for adjusting costs, parameters, etc. used in determining favorability ratings and/or vehicle service provider rankings to facilitate changing needs and/or requirements of the service entity. For instance, the service entity can tune the ratings and/or rankings to adjust the mix of supply for performing vehicle services, for example, to improve driver experience and/or third party vendor experience, to ensure that vehicles are available to service areas as needed, and/or the like.

According to another aspect of the present disclosure, in some implementations, the systems and methods can provide for generating feedback associated with the assignment and performance of vehicle services. For example, in some implementations, the service entity can obtain and store data associated with what type of vehicle services and/or routes are being accepted and/or rejected by various vehicle service providers.

In some implementations, the service entity can aggregate and analyze such stored feedback data for use in tuning one or more costs used in generating ratings and/or vehicle service provider rankings. In some implementations, the service entity can use stored feedback data to provide supply performance tracking. For example, the service entity use supply performance tracking in analyzing the overall performance of vehicle service providers. In some implementations, the service entity use supply performance tracking in determining ratings for various vehicle service providers.

Various means can be configured to perform the methods and processes described herein. For example, a computing system can include data obtaining unit(s), favorability/rating determining unit(s), availability determination unit(s), vehicle ranking determination unit(s), vehicle selection determination unit(s), assignment data generation unit(s), data providing unit(s), and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry, for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means can be configured to obtain data, for example, from a user, a vehicle service provider, and/or the like. For example, the means can be configured to facilitate obtaining transportation service request data from a user. As another example, the means can be configured to facilitate obtaining availability data, transportation service assignment acceptance data, and/or the like from a vehicle service provider. A data obtaining unit is an example of means for obtaining such data from a user, a vehicle service provider, and/or the like at a service entity system as described herein.

The means can be configured to determine ratings. For example, the means can be configured to determine ratings for transportation service requests that are indicative of whether a human driver would prefer to service the transportation service request with a human driven vehicle. A favorability determining unit is one example of a means for determining ratings as described herein.

The means can be configured to determine availability of vehicle service providers. For example, the means can be configured to determine the availability of a plurality of vehicle providers (e.g., active in the service entity system but not currently performing a vehicle service, maintenance service, etc.) with regard to performing a transportation service request. An availability determination unit is one example of a means for determining availability of vehicle service providers as described herein.

The means can be configured to determine ranking data for a plurality of available vehicle service providers. For example, the means can be configured to determine ranking data associated with one or more of the available vehicle service providers based at least in part on the transportation service request, ratings, operation capabilities, and/or the like. A vehicle ranking determination unit is one example of a means for determining ranking data for a plurality of available vehicle service providers as described herein.

The means can be configured to determine at least one selected vehicle service provider for the transportation service request. For example, the means can be configured to determine at least one selected vehicle service provider from the available vehicle service providers based at least in part on the ranking data. A vehicle selection determination unit is one example of a means for determining selected vehicle service provider(s) for the transportation service request as described herein.

The means can be configured to generate vehicle service assignment data associated with the performance of the transportation service request. An assignment data generation unit is one example of a means for generating vehicle service assignment data associated with the performance of the transportation service request as described herein.

The means can be configured to provide the vehicle service assignment data to the selected vehicle service provider(s). For example, the means can be configured to provide the vehicle service assignment data to the selected vehicle service provider(s) to obtain an acceptance of performance of the vehicle service associated with the transportation service request. A data providing unit is one example of a means for providing the vehicle service assignment data to the selected vehicle service provider(s) as described herein

The systems and methods described herein provide a number of technical effects and benefits. For instance, the systems and methods can provide improvements in driver experience by determining the value and/or incentives for a human driver for performance of a vehicle service and determining when vehicle services may be more suited to assignment to an autonomous vehicle when determining vehicle service assignments. The systems and methods described herein also provide additional technical effects and benefits including improving efficiency in vehicle service assignment allocation and improving supply management. For example, by determining favorability ratings and vehicle service provider rankings, the systems and methods described herein can provide for quicker acceptance of vehicle service assignment offers and/or reductions in rejected vehicle service offers by vehicle service providers.

The systems and methods of the present disclosure can provide an improvement to vehicle computing technology, such as autonomous vehicle computing technology and the remote computing systems associated therewith. For instance, the use of favorability ratings and vehicle service provider rankings can provide for improvements in the use of communication resources and processing resources by streamlining the determination of vehicle service providers that should be offered a vehicle service assignment thereby reducing resources required to communicate and facilitate assignment of a vehicle service.

With reference to the figures, example embodiments of the present disclosure will be discussed in further detail.

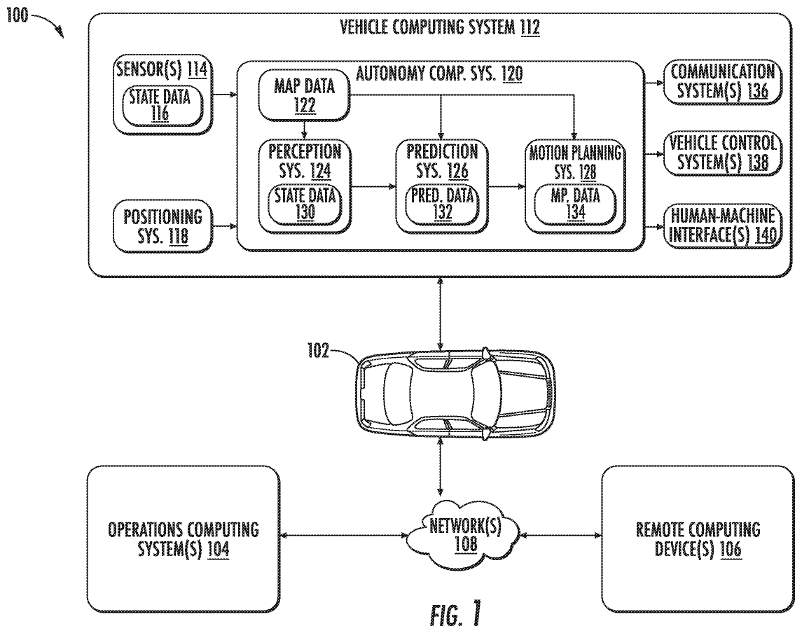

FIG. 1 depicts a block diagram of an example system 100 for controlling the navigation of an autonomous vehicle according to example embodiments of the present disclosure. As illustrated, FIG. 1 shows a system 100 that can include a vehicle 102; an operations computing system 104; one or more remote computing devices 106; a communication network 108; a vehicle computing system 112; one or more sensors 114; sensor data 116; a positioning system 118; an autonomy computing system 120; map data 122; a perception system 124; a prediction system 126; a motion planning system 128; state data 130; prediction data 132; motion plan data 134; a communication system 136; a vehicle control system 138; and a human-machine interface 140. The vehicle 102 can be an autonomous vehicle.

The operations computing system 104 can be associated with a service entity that can provide one or more vehicle services to a plurality of users via a fleet of vehicles that includes, for example, the vehicle 102. The vehicle services can include transportation services (e.g., rideshare services), courier services, delivery services, and/or other types of services. The operations computing system 104 can be remote from the vehicle 102.

The operations computing system 104 can include multiple components for performing various operations and functions. For example, the operations computing system 104 can include and/or otherwise be associated with the one or more computing devices that are remote from the vehicle 102. The one or more computing devices of the operations computing system 104 can include one or more processors and one or more memory devices. The one or more memory devices of the operations computing system 104 can store instructions that when executed by the one or more processors cause the one or more processors to perform operations and functions associated with the service entity, the operation of one or more vehicles (e.g., a fleet of vehicles), with supporting the provision of vehicle services, and/or other operations as discussed herein.

For example, the operations computing system 104 can be configured to monitor and communicate with the vehicle 102 and/or its users to coordinate a vehicle service provided by the vehicle 102. To do so, the operations computing system 104 can manage a database that includes data including vehicle status data associated with the status of vehicles including the vehicle 102. The vehicle status data can include a state of a vehicle, a location of a vehicle (e.g., a latitude and longitude of a vehicle), the availability of a vehicle (e.g., whether a vehicle is available to pick-up or drop-off passengers and/or cargo, etc.), and/or the state of objects internal and/or external to a vehicle (e.g., the physical dimensions and/or appearance of objects internal/external to the vehicle).

The operations computing system 104 can communicate with the one or more remote computing devices 106 and/or the vehicle 102 via one or more communications networks including the communications network 108. The communications network 108 can exchange (send or receive) signals (e.g., electronic signals) or data (e.g., data from a computing device) and include any combination of various wired (e.g., twisted pair cable) and/or wireless communication mechanisms (e.g., cellular, wireless, satellite, microwave, and radio frequency) and/or any desired network topology (or topologies). For example, the communications network 108 can include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 102.

Each of the one or more remote computing devices 106 can include one or more processors and one or more memory devices. The one or more memory devices can be used to store instructions that when executed by the one or more processors of the one or more remote computing devise 106 cause the one or more processors to perform operations and/or functions including operations and/or functions associated with the vehicle 102 including exchanging (e.g., sending and/or receiving) data or signals with the vehicle 102, monitoring the state of the vehicle 102, and/or controlling the vehicle 102. The one or more remote computing devices 106 can communicate (e.g., exchange data and/or signals) with one or more devices including the operations computing system 104 and the vehicle 102 via the communications network 108. In some implementations, the one or more remote computing device(s) 106 can be associated with a third party such as, for example, a third party vehicle vendor with a fleet of third party vehicles. The remote computing device(s) 106 can implement the computing system of the third party (e.g., for communication/coordination/operation of third party autonomous vehicles).

The one or more remote computing devices 106 can include one or more computing devices (e.g., a desktop computing device, a laptop computing device, a smart phone, and/or a tablet computing device) that can receive input or instructions from a user or exchange signals or data with an item or other computing device or computing system (e.g., the operations computing system 104). Further, the one or more remote computing devices 106 can be used to communicate data to and/or obtain data from a vehicle, and determine and/or modify one or more states of the vehicle 102 including a location (e.g., a latitude and longitude), a velocity, acceleration, a trajectory, and/or a path of the vehicle 102 based in part on signals or data exchanged with the vehicle 102. In some implementations, the operations computing system 104 can include the one or more remote computing devices 106.

The vehicle 102 can be a ground-based vehicle (e.g., an automobile, light electric vehicle, bicycle, scooter, etc.), an aircraft, and/or another type of vehicle (e.g., watercraft, etc.). The vehicle 102 can be an autonomous vehicle that can perform various actions including driving, navigating, and/or operating, with minimal and/or no interaction from a human driver. The autonomous vehicle 102 can be configured to operate in one or more modes including, for example, a fully autonomous operational mode, a semi-autonomous operational mode, a park mode, and/or a sleep mode. A fully autonomous (e.g., self-driving) operational mode can be one in which the vehicle 102 can provide driving and navigational operation with minimal and/or no interaction from a human driver present in the vehicle. A semi-autonomous operational mode can be one in which the vehicle 102 can operate with some interaction from a human driver present in the vehicle. Park and/or sleep modes can be used between operational modes while the vehicle 102 performs various actions including waiting to provide a subsequent vehicle service, and/or recharging between operational modes.

An indication, record, and/or other data indicative of the state of the vehicle, the state of one or more passengers of the vehicle, and/or the state of an environment including one or more objects (e.g., the physical dimensions and/or appearance of the one or more objects) can be stored locally in one or more memory devices of the vehicle 102. Additionally, the vehicle 102 can provide data indicative of the state of the vehicle, the state of one or more passengers of the vehicle, and/or the state of an environment to the operations computing system 104, which can store an indication, record, and/or other data indicative of the state of the one or more objects within a predefined distance of the vehicle 102 in one or more memory devices associated with the operations computing system 104 (e.g., remote from the vehicle). Furthermore, the vehicle 102 can provide data indicative of the state of the one or more objects (e.g., physical dimensions and/or appearance of the one or more objects) within a predefined distance of the vehicle 102 to the operations computing system 104, which can store an indication, record, and/or other data indicative of the state of the one or more objects within a predefined distance of the vehicle 102 in one or more memory devices associated with the operations computing system 104 (e.g., remote from the vehicle).

The vehicle 102 can include and/or be associated with the vehicle computing system 112. The vehicle computing system 112 can include one or more computing devices located onboard the vehicle 102. For example, the one or more computing devices of the vehicle computing system 112 can be located on and/or within the vehicle 102. The one or more computing devices of the vehicle computing system 112 can include various components for performing various operations and functions. For instance, the one or more computing devices of the vehicle computing system 112 can include one or more processors and one or more tangible, non-transitory, computer readable media (e.g., memory devices). The one or more tangible, non-transitory, computer readable media can store instructions that when executed by the one or more processors cause the vehicle 102 (e.g., its computing system, one or more processors, and other devices in the vehicle 102) to perform operations and functions, including those of the vehicle described herein.

As depicted in FIG. 1, the vehicle computing system 112 can include the one or more sensors 114; the positioning system 118; the autonomy computing system 120; the communication system 136; the vehicle control system 138; and the human-machine interface 140. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The onboard systems can exchange (e.g., send and/or receive) data, messages, and/or signals amongst one another via the communication channel.

The one or more sensors 114 can be configured to generate and/or store data including the sensor data 116 associated with one or more objects that are proximate to the vehicle 102 (e.g., within range or a field of view of one or more of the one or more sensors 114). The one or more autonomy system sensors 114 can include a Light Detection and Ranging (LIDAR) system, a Radio Detection and Ranging (RADAR) system, one or more cameras (e.g., visible spectrum cameras and/or infrared cameras), motion sensors, and/or other types of imaging capture devices and/or sensors. The autonomy sensor data 116 can include image data, radar data, LIDAR data, and/or other data acquired by the one or more autonomy system sensors 114. The one or more objects can include, for example, pedestrians, vehicles, bicycles, and/or other objects. The one or more sensors can be located on various parts of the vehicle 102 including a front side, rear side, left side, right side, top, or bottom of the vehicle 102. The sensor data 116 can be indicative of locations associated with the one or more objects within the surrounding environment of the vehicle 102 at one or more times. For example, the sensor data 116 can be indicative of one or more LIDAR point clouds associated with the one or more objects within the surrounding environment. The one or more sensors 114 can provide the sensor data 116 to the autonomy computing system 120.

In addition to the sensor data 116, the autonomy computing system 120 can retrieve or otherwise obtain data including the map data 122. The map data 122 can provide detailed information about the surrounding environment of the vehicle 102. For example, the map data 122 can provide information regarding: the identity and location of different roadways, road segments, buildings, or other items or objects (e.g., lampposts, crosswalks and/or curb); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); and/or any other map data that provides information that assists the vehicle computing system 112 in processing, analyzing, and perceiving its surrounding environment and its relationship thereto.

The vehicle computing system 112 can include a positioning system 118. The positioning system 118 can determine a current position of the vehicle 102. The positioning system 118 can be any device or circuitry for analyzing the position of the vehicle 102. For example, the positioning system 118 can determine position by using one or more of inertial sensors, a satellite positioning system, based on IP/MAC address, by using triangulation and/or proximity to network access points or other network components (e.g., cellular towers and/or Wi-Fi access points) and/or other suitable techniques. The position of the vehicle 102 can be used by various systems of the vehicle computing system 112 and/or provided to one or more remote computing devices (e.g., the operations computing system 104 and/or the remote computing device(s) 106). For example, the map data 122 can provide the vehicle 102 relative positions of the surrounding environment of the vehicle 102. The vehicle 102 can identify its position within the surrounding environment (e.g., across six axes) based at least in part on the data described herein. For example, the vehicle 102 can process the autonomy sensor data 116 (e.g., LIDAR data, camera data) to match it to a map of the surrounding environment to get an understanding of the vehicle's position within that environment (e.g., transpose the vehicle's position within its surrounding environment).

The autonomy computing system 120 can include a perception system 124, a prediction system 126, a motion planning system 128, and/or other systems that cooperate to perceive the surrounding environment of the vehicle 102 and determine a motion plan for controlling the motion of the vehicle 102 accordingly. The perception system 124, prediction system 126, and/or motion planning system can be separate systems or included within the same system. The autonomy computing system 120 can receive the autonomy sensor data 116 from the one or more autonomy system sensors 114, attempt to determine the state of the surrounding environment by performing various processing techniques on the autonomy sensor data 116 (and/or other data), and generate an appropriate motion plan through the surrounding environment. The autonomy computing system 120 can control the one or more vehicle control systems 138 to operate the vehicle 102 according to the motion plan.

The perception system 124 can identify one or more objects that are proximate to the vehicle 102 based on sensor data 116 received from the sensors 114. In particular, in some implementations, the perception system 124 can determine, for each object, state data 130 that describes a current state of such object. As examples, the state data 130 for each object can describe an estimate of the object's: current location (also referred to as position); current speed; current heading (which may also be referred to together as velocity); current acceleration; current orientation; size/footprint (e.g., as represented by a bounding shape such as a bounding polygon or polyhedron); class of characterization (e.g., vehicle class versus pedestrian class versus bicycle class versus other class); yaw rate; and/or other state information. In some implementations, the perception system 124 can determine state data 130 for each object over a number of iterations. In particular, the perception system 124 can update the state data 130 for each object at each iteration. Thus, the perception system 124 can detect and track objects (e.g., vehicles, bicycles, pedestrians, etc.) that are proximate to the vehicle 102 over time, and thereby produce a representation of the environment around an vehicle 102 along with its state (e.g., a presentation of the objects of interest within a scene at the current time along with the states of the objects).

The prediction system 126 can receive the state data 130 from the perception system 124 and predict one or more future locations and/or moving paths for each object based on such state data. For example, the prediction system 126 can generate prediction data 132 associated with each of the respective one or more objects proximate to the vehicle 102. The prediction data 132 can be indicative of one or more predicted future locations of each respective object. The prediction data 132 can be indicative of a predicted path (e.g., predicted trajectory made of waypoints) of at least one object within the surrounding environment of the vehicle 102. For example, the predicted path (e.g., trajectory) can indicate a path along which the respective object is predicted to travel over time (and/or the velocity at which the object is predicted to travel along the predicted path). The prediction system 126 can provide the prediction data 132 associated with the one or more objects to the motion planning system 128.

The motion planning system 128 can determine a motion plan and generate motion plan data 134 for the vehicle 102 based at least in part on the prediction data 132 (and/or other data). The motion plan data 134 can include vehicle actions with respect to the objects proximate to the vehicle 102 as well as the predicted movements. For instance, the motion planning system 128 can implement an optimization algorithm that considers cost data associated with a vehicle action as well as other objective functions (e.g., cost functions based on speed limits, traffic lights, and/or other aspects of the environment), if any, to determine optimized variables that make up the motion plan data 134. By way of example, the motion planning system 128 can determine that the vehicle 102 can perform a certain action (e.g., pass an object) without increasing the potential risk to the vehicle 102 and/or violating any traffic laws (e.g., speed limits, lane boundaries, signage). The motion plan data 134 can include a planned trajectory, velocity, acceleration, and/or other actions of the vehicle 102.

As one example, in some implementations, the motion planning system 128 can determine a cost function for each of one or more candidate motion plans for the autonomous vehicle 102 based at least in part on the current locations and/or predicted future locations and/or moving paths of the objects. For example, the cost function can describe a cost (e.g., over time) of adhering to a particular candidate motion plan. For example, the cost described by a cost function can increase when the autonomous vehicle 102 approaches impact with another object and/or deviates from a preferred pathway (e.g., a predetermined travel route).

Thus, given information about the current locations and/or predicted future locations and/or moving paths of objects, the motion planning system 128 can determine a cost of adhering to a particular candidate pathway. The motion planning system 128 can select or determine a motion plan for the autonomous vehicle 102 based at least in part on the cost function(s). For example, the motion plan that minimizes the cost function can be selected or otherwise determined. The motion planning system 128 then can provide the selected motion plan to a vehicle controller that controls one or more vehicle controls (e.g., actuators or other devices that control gas flow, steering, braking, etc.) to execute the selected motion plan.

The motion planning system 128 can provide the motion plan data 134 with data indicative of the vehicle actions, a planned trajectory, and/or other operating parameters to the vehicle control systems 138 to implement the motion plan data 134 for the vehicle 102. For instance, the vehicle 102 can include a mobility controller configured to translate the motion plan data 134 into instructions. By way of example, the mobility controller can translate a determined motion plan data 134 into instructions for controlling the vehicle 102 including adjusting the steering of the vehicle 102 “X” degrees and/or applying a certain magnitude of braking force. The mobility controller can send one or more control signals to the responsible vehicle control component (e.g., braking control system, steering control system and/or acceleration control system) to execute the instructions and implement the motion plan data 134.

The vehicle computing system 112 can include a communications system 136 configured to allow the vehicle computing system 112 (and its one or more computing devices) to communicate with other computing devices. The vehicle computing system 112 can use the communications system 136 to communicate with the operations computing system 104 and/or one or more other remote computing devices (e.g., the one or more remote computing devices 106) over one or more networks (e.g., via one or more wireless signal connections, etc.). In some implementations, the communications system 136 can allow communication among one or more of the system on-board the vehicle 102. The communications system 136 can also be configured to enable the autonomous vehicle to communicate with and/or provide and/or receive data and/or signals from a remote computing device 106 associated with a user and/or an item (e.g., an item to be picked-up for a courier service). The communications system 136 can utilize various communication technologies including, for example, radio frequency signaling and/or Bluetooth low energy protocol. The communications system 136 can include any suitable components for interfacing with one or more networks, including, for example, one or more: transmitters, receivers, ports, controllers, antennas, and/or other suitable components that can help facilitate communication. In some implementations, the communications system 136 can include a plurality of components (e.g., antennas, transmitters, and/or receivers) that allow it to implement and utilize multiple-input, multiple-output (MIMO) technology and communication techniques.

The vehicle computing system 112 can include the one or more human-machine interfaces 140. For example, the vehicle computing system 112 can include one or more display devices located on the vehicle computing system 112. A display device (e.g., screen of a tablet, laptop, and/or smartphone) can be viewable by a user of the vehicle 102 that is located in the front of the vehicle 102 (e.g., driver's seat, front passenger seat). Additionally, or alternatively, a display device can be viewable by a user of the vehicle 102 that is located in the rear of the vehicle 102 (e.g., a back passenger seat)

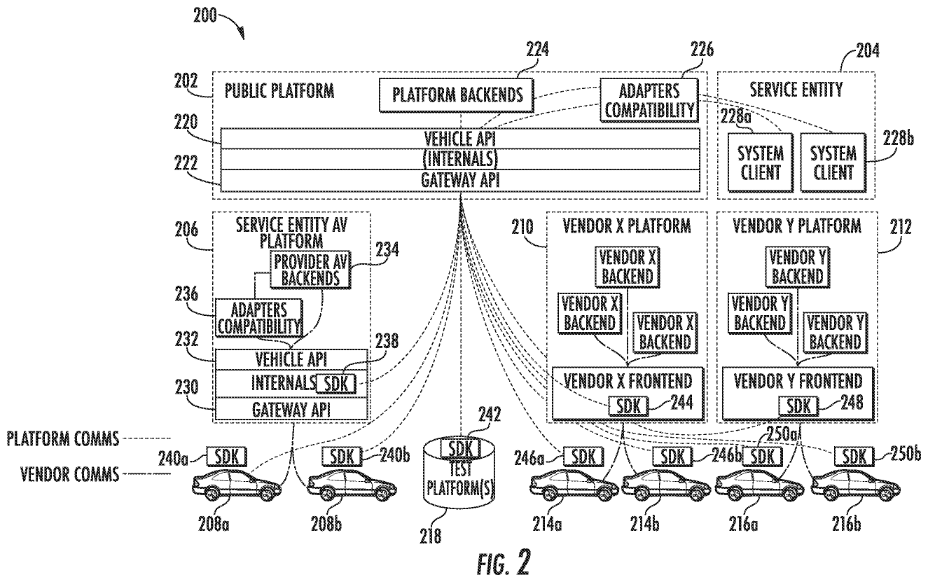

FIG. 2 depicts an example service infrastructure 200 according to example embodiments of the present disclosure. As described below, the service infrastructure 200 can include one or more components that are included in a service entity computing system for coordinating the type of vehicle deployment and control of the present disclosure.

As illustrated in FIG. 2, an example service infrastructure 200, according to example embodiments of the present disclosure, can include an application programming interface platform (e.g., public platform) 202, a service entity system 204, a service entity autonomous vehicle platform (e.g., private platform) 206, one or more service entity autonomous vehicles (e.g., first party autonomous vehicles in a service entity fleet) such as autonomous vehicles 208a and 208b, and one or more test platforms 218. For example, the service entity may own, lease, etc. a fleet of autonomous vehicles that can be managed by the service entity (e.g., its backend system clients) to provide one or more vehicle services. The autonomous vehicle(s) 208a, 208b utilized to provide the vehicle service(s) can be included in this fleet of the service entity. Such autonomous vehicle may be referred to as “service entity autonomous vehicles” or “first party autonomous vehicles.” Additionally, the service infrastructure 200 can also be associated with and/or in communication with one or more third-party entity systems such as vendor platforms 210 and 212, and/or one or more third-party entity autonomous vehicles (e.g., in a third-party entity autonomous vehicle fleet) such as autonomous vehicles 214a, 214b, 216a, and 216b. For instance, the autonomous vehicle 214a, 214b, 216a, and 216b can be associated with a third party vehicle provider such as, for example, an individual, an original equipment manufacturer (OEM), a third party vendor, or another entity. These autonomous vehicles may be referred to as “third party autonomous vehicles.” Even though such an autonomous vehicle 214a, 214b, 216a, and 216b may not be included in the fleet of autonomous vehicles of the service entity, the service entity infrastructure 200 can include a platform that can allow the autonomous vehicle(s) 214a, 214b, 216a, and 216b associated with a third party to still be utilized to provide the vehicle services offered by the service entity, access the service entity's system clients, and/or the like.

In some implementations, the VIP component described herein can include one or more of the platforms and related components illustrated in the service infrastructure 200 of FIG. 2. As described herein, a service infrastructure 200 can include a public platform 202 to facilitate vehicle services (e.g., provided via one or more system clients (228a, 228b) associated with a service entity operations computing system) between the service entity infrastructure system 204 (e.g., operations computing system, etc.) and vehicles associated with one or more entities (e.g., vehicles associated with the service entity (208a, 208b), vehicles associated with third-party entities (214a, 214b, 216a, 216b), etc.). For example, in some embodiments, the public platform 202 can provide access to services (e.g., associated with the service provider system 204) such as trip assignment services, routing services, supply positioning services, payment services, and/or the like.

The public platform 202 can include a gateway API (e.g., gateway API 222) to facilitate communication from the autonomous vehicles to the service entity infrastructure services (e.g., system clients 228a, 228b, etc.) and a vehicle API (e.g., vehicle API 220) to facilitate communication from the service entity infrastructure services (e.g., system clients 228a, 228b, etc.) to the vehicles (e.g., 208a, 208b, 214a, 214b, 216a, 216b). For example, the public platform 202, using the vehicle API 220, can query the vehicles (e.g., 208a, 208b, 214a, 214b, 216a, 216b) and/or third party systems/platforms to determine an availability (e.g., to accept a vehicle service assignment, vehicle operational capability, etc. The vehicles and/or other systems can transmit data (e.g., availability data, operational capability data, etc.) to the public platform 202 using the gateway API 222.

In some embodiments, the public platform 202 can be a logical construct that contains all vehicle and/or service facing interfaces. The public platform 202 can include a plurality of backend services interfaces (e.g., public platform backend interfaces 224). Each backend interface 224 can be associated with at least one system client (e.g., service provider system 204 clients such as system clients 228a and 228b). A system client (e.g., 228a, 228b, etc.) can be the hardware and/or software implemented on a computing system (e.g., operations computing system of the service entity) that is remote from the vehicle and that provides a particular back-end service to a vehicle (e.g., scheduling of vehicle service assignments, routing services, payment services, user services, vehicle rating services, etc.). A backend interface 224 can be the interface (e.g., a normalized interface) that allows one application and/or system (e.g., of the autonomous vehicle) to provide data to and/or obtain data from another application and/or system (e.g., a system client). Each backend interface 224 can have one or more functions that are associated with the particular backend interface. A vehicle can provide a communication to the public platform 202 to call a function of a backend interface. In this way, the backend interface(s) 224 can be an external facing edge of the service entity infrastructure system 204 that is responsible for providing a secure tunnel for a vehicle and/or other system to communicate with a particular service provider system client (e.g., 228a, 228b, etc.) so that the vehicle and/or other system can utilize the backend service associated with that particular service entity system client (e.g., 228a, 228b, etc.), and vice versa.

In some embodiments, the public platform 202 can include one or more adapters 226, for example, to provide compatibility between one or more backend interfaces 224 and one or more service entity system clients (e.g., 228a, 228b, etc.). In some embodiments, the adapter(s) 226 can provide upstream and/or downstream separation between the service entity operations computing system 204 (e.g., system clients 228a, 228b, etc.) and the public platform 202 (e.g., backend interfaces 224, etc.). In some embodiments, the adapter(s) 226 can provide or assist with data curation from upstream services (e.g., system clients), flow normalization and/or consolidation, extensity, and/or the like.

The service infrastructure 200 can include a private platform 206 to facilitate service provider-specific (e.g., internal, proprietary, etc.) vehicle services (e.g., provided via one or more system clients (228a, 228b) associated with the service entity operations computing system) between the service entity infrastructure system 204 (e.g., operations computing system, etc.) and vehicles associated with the service entity (e.g., vehicles 208a, 208b). For example, in some embodiments, the private platform 206 can provide access to service entity services that are specific to the service entity vehicle fleet (e.g., first party autonomous vehicles 208a and 208b) such as fleet management services, autonomy assistance services, and/or the like.

The private platform 206 can include a gateway API (e.g., gateway API 230) to facilitate communication from the vehicles 208a, 208b to one or more service entity infrastructure services (e.g., via the public platform 202, via one or more service entity autonomous vehicle backend interfaces 234, etc.) and a vehicle API (e.g., vehicle API 232) to facilitate communication from the service entity infrastructure services (e.g., via the public platform 202, via one or more service provider vehicle backend interfaces 234, etc.) to the vehicles 208a, 208b. The private platform 206 can include one or more backend interfaces 234 associated with at least one system client (e.g., service provider vehicle-specific system clients, such as fleet management, autonomy assistance, etc.). In some embodiments, the private platform 206 can include one or more adapters 236, for example, to provide compatibility between one or more service entity vehicle backend interfaces 234 and one or more private platform APIs (e.g., vehicle API 232, gateway API 230).

In some embodiments, the service infrastructure 200 can include a test platform 218 for validating and vetting end-to-end platform functionality, without use of a real vehicle on the ground. For example, the test platform 218 can simulate trips with human drivers and/or support fully simulated trip assignment and/or trip workflow capabilities.

The service infrastructure 200 can be associated with and/or in communication with one or more third-party entity systems, such as third-party entity (e.g., Vendor X) platform 210 and third-party entity (e.g., Vendor Y) platform 212, and/or one or more third-party entity vehicles (e.g., in a third-party entity vehicle fleet) such as third-party vehicles 214a, 214, 216a, and 216b. The third-party entity platforms 210, 212 can be distinct and remote from the service provide infrastructure and provide for management of vehicles associated with a third-party entity fleet, such as third-party entity (e.g., Vendor X) vehicles 214a, 214b and third-party entity (e.g., Vendor Y) vehicles 216a, 216b. The third-party entity (e.g., Vendor X) platform 210 and third-party entity (e.g., Vendor Y) platform 212, and/or third-party entity (e.g., Vendor X) vehicles 214a, 214b and third-party entity (e.g., Vendor Y) vehicles 216a, 216b can communicate with the service entity operations computing system 204 (e.g., system clients, etc.) via the public platform 202 to allow the third-party entity platforms and/or vehicles to access one or more service entity infrastructure services (e.g., trip services, routing services, payment services, user services, etc.).

The service infrastructure 200 can include a plurality of software development kits (SDKs) (e.g., set of tools and core libraries), such as SDKs 238, 240a, 240b, 242, 244, 246a, 246b, 248, 250a, and 250b, that provide access to the public platform 202 for use by both the service provider autonomous vehicles (208a, 208b) and the third-party entity vehicles (214a, 214b, 216a, 216b). In some implementations, all external communication with the platforms can be done via the SDKs. For example, the provider entity infrastructure can include both a public SDK and a private SDK and specific endpoints to facilitate communication with the public platform 202 and the private platform 206, respectively. In some embodiments, the service entity vehicle fleet (e.g., vehicle 208a, 208b) and/or test platform 218 can use both the public SDK and the private SDK, whereas the third-party entity autonomous vehicles (vehicle 214a, 214b, 216a, 216b) can use only the public SDK and associated endpoints. In some implementations, the SDKs can provide a single entry point into the service entity infrastructure (e.g., public platform 202, etc.), which can improve consistency across both the service provider fleet and the third-party entity fleet(s). As an example, a public SDK can provide secured access to the public platform 202 by both service entity vehicles and third-party entity (and/or systems) and access to capabilities such as trip assignment, routing, onboarding new vehicles, supply positioning, monitoring and statistics, a platform sandbox (e.g., for integration and testing), and/or the like. The private SDK can be accessed by the service entity vehicles and provide access to capabilities such as remote assistance, vehicle management, operational data access, fleet management, and/or the like.

In some embodiments, the SDKs can include a command-line interface to provide an entry point into the SDK components and act as a gateway for SDK related work, integration, testing, and authentication. For example, the command-line tools can provide for bootstrapping, managing authentication, updating SDK version, testing, debugging, and/or the like. In some implementations, a command-line interface can require an authentication certificate before being able to bootstrap an SDK, download components, and/or access a service entity's services. For example, based on the authentication certificate, a command-line interface can determine which version of the SDK (e.g., public or private) to which to provide access.

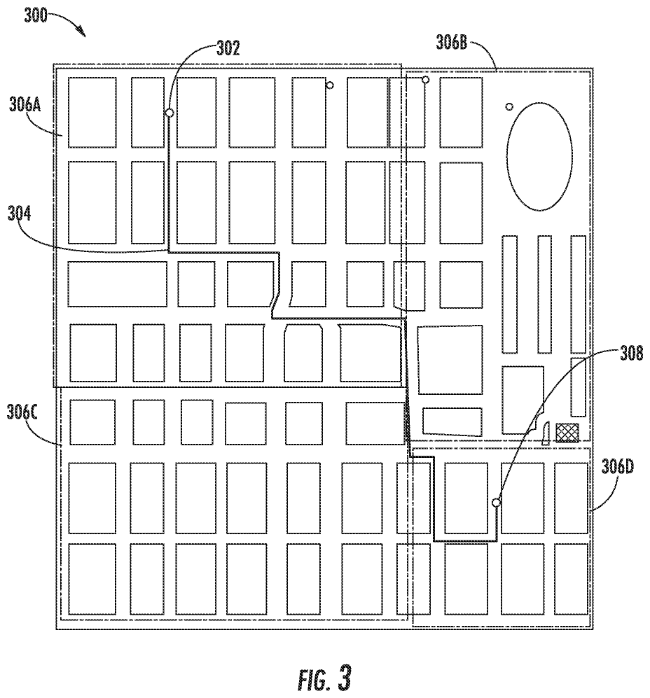

FIG. 3 depicts an example of routing for a vehicle service according to example embodiments of the present disclosure. As illustrated, FIG. 3 shows a geographic area 300 depicting a service origin 302; a route 304; an area risk profile(s) (e.g., 306A, 306B, 306C, 306D); and a service destination 308.

The service origin 302 can be a location (e.g., a latitude and longitude, address, semantic place name, intersection, etc.) considered the start of the route. This location can be the current location of the vehicle assigned to the transportation service request, the location of a user associated with a service request, and/or a location determined by the service infrastructure 200. In some embodiments, the service origin 302 can be one parameter of a transportation service request, as further described herein.

The service destination 308 can be a location (e.g., a latitude and longitude, address, semantic place name, intersection, etc.) considered the endpoint of the route. This location can be determined by the service infrastructure 200. In some embodiments, the service destination 308 can be a parameter of a transportation service request.

A service entity computing system (e.g., the system component 204 of service infrastructure 200) can be configured to perform the routing functions. For example, the service entity computing system 204 can calculate the route 304 (e.g., a path) between the service origin 302 and the service destination 308. The service entity computing system 204 can determine a route using a number of factors including but not limited to distance, vehicle fuel levels, projected travel time, projected traffic levels, potential pooling of other users, area risk profiles associated with certain geographic areas, and other factors. For example, the service entity computing system 204 may determine a more direct route to conserve vehicle fuel levels. For another example, the service entity computing system 204 may determine a more circuitous route to avoid projected traffic levels and/or to reduce projected travel time.

In some embodiments, the service entity computing system 204 can consider an area risk profile(s) (e.g., 306A, 306B, 306C, 306D) associated with one or more areas to be traveled for the transportation service request. For instance, an area risk profile can be associated with (e.g., obtained, stored, etc.) one or more areas within a geographic region where vehicle services are provided. In one example, the risk profile for an area can be indicative of the risk to a vehicle and/or its human driver in the area (e.g., areas where it may be dangerous for a driver carrying a large amount of currency, high crime rate, etc.). In another example, the risk profile for an area can be indicative of the risk to an autonomous vehicle (e.g., areas where an autonomous vehicle operation may not be safe, more susceptible to damage, etc.). The risk profiles 306A, 306B, 306C, 306D can be determined based at least in part on historic, current, and/or future projected: crime statistics, reported vehicle instances, human/vehicle traffic data, and/or other types of data, etc. Such data can be obtained from accessible third party databases (e.g., municipality databases, etc.) and/or generated based on information provided by autonomous vehicles and/or human drivers (e.g., reported instances).

In some implementations, the service entity computing system 204 can determine a route 302 at least partially based on area risk profile(s) 308 associated with one or more areas to be traveled for the transportation service request. For example, the service entity computing system 204 may determine an alternative route to avoid navigating the vehicle through an area associated with a certain area risk profile.

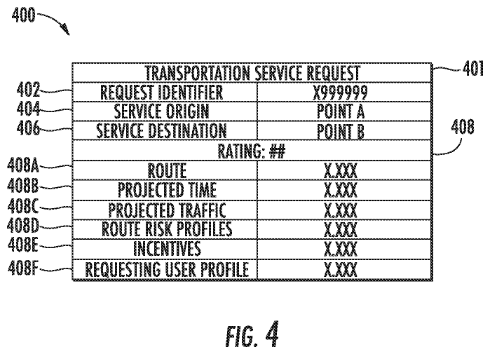

FIG. 4 depicts an example data structure 400 associated with a transportation service request 401 according to example embodiments of the present disclosure. As illustrated, FIG. 4 depicts a data structure 400 (e.g., list, hierarchy, tree, table, and/or other data structure) that can include a request identifier 402; a service origin 404; and a service destination 406.

The service entity computing system 204 can obtain data indicative of transportation service request 401. The transportation service request 401 can be transmitted to and/or generated by the service entity computing system 204. The service entity computing system 204 can determine the source of the transportation service request 401 by the data stored in the request identifier 402 (e.g., associated with a user, user device, etc.). The service entity computing system 204 can be further configured to determine a route between the service origin 404 and the service destination 406. In some implementations, the route can be used as a rating parameter 408A of the transportation service request, as further described herein.

For example, the service entity computing system 204 (e.g., of service infrastructure 200) could receive a transportation service request 401 via an application executed by a user device (e.g., smart phone, tablet, wearable device, other computing device, etc.). The request identifier 402 can identify the user and/or user device responsible for transmitting the service request. The service origin 404 can identify the user device's current location, or a location desired by the user device. The service entity computing system 204 can determine the service destination 406 from the transportation service request, which can identify the location the user devices has marked as the destination. In some implementations, the service entity computing system 204 can obtain the transportation service request 401 via a cloud-based third party computing system.

In some implementations, the service entity computing system 204 can generate the transportation service request 401. For example, the service entity computing system 204 can generate a transportation service request 401 based at least in part on a previous arrangement by which a user is to be transported (e.g., to recurrently transport a user to a hospital, appointment, job, etc.). This previous arrangement can be implemented by the service entity computing system 204, rather than an on-demand arrangement.

The service entity computing system 204 can determine whether a human driver (of a human driven vehicle) would prefer to service the transportation service request 401 with a human driven vehicle based at least in part on the data indicative of the transportation service request 401.

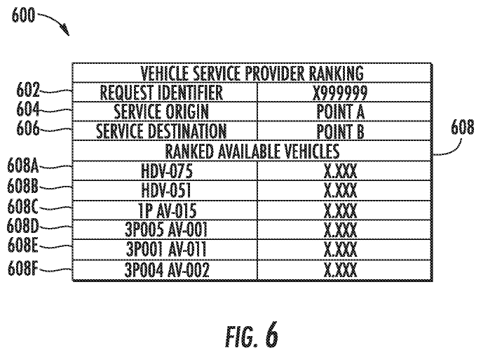

To do so, the service entity computing system 204 can determine a rating 408 that indicates whether the human driver would prefer to service the transportation service request 408 with the human driven vehicle (“a human driver favorability rating”). This can indicate the favorability of servicing the transportation service request 401 for a human driven vehicle (e.g., the value, incentives, etc. for a human driven vehicle to perform the service(s)). The service entity computing system 204 can determine that the human driver would not prefer to service the transportation service request 401 based at least in part on the rating 408. Additionally, or alternatively, as will be further described herein with reference to FIG. 6, the rating 408 can be used in determining ranking data associated with available vehicle service providers (e.g., one or more human driven vehicles, one or more service entity autonomous vehicles, one or more third party vendor autonomous vehicles, etc.).

By way of example, the service entity computing system 204 can determine the rating 408 based in part on one or more rating parameters 408A-F associated with the transportation service request 401 that may be indicative of the favorability to a human driver. The service entity computing system 204 can obtain data indicative of the rating parameter(s) 408A-F of the transportation service request 401. The rating parameters can utilize an arbitrary numerical scale (e.g., one to ten, zero to one hundred, etc.) or any other scale/representation that is suitable. Individual rating parameters (e.g., route 408A, projected time 408B, projected traffic 408C, route risk profiles 408D, incentives 408E, and requesting user profile 408F) can be determined by the service entity computing system 204, determined by the user device transmitting the transportation service request to the service infrastructure 200, or both. For example, the service entity computing system 204 can determine the route 408A based on the origin and destination associated with the transportation service request 401 (e.g., using the routing service described herein), and/or the risk profile(s) 408D of the area(s) associated with that route 408A. In another example, a user device transmitting the transportation service request 401 may determine the requesting user profile (e.g., the profile associated with the requesting user and/or user device). The rating parameters 408 can be used, either individually or collectively, by the service entity computing system 204 to determine if a human driver would prefer to service the transportation request 400.

In some implementations, the rating 408 can be based at least in part on a route 408 associated with the transportation service request 401, a projected time associated with the transportation service request 401, a destination associated with the transportation service request 401, etc. For example, the type of a route 408 may be less favorable to a human driven vehicle than an autonomous vehicle, such as short routes, dead heading routes (e.g., where a return service assignment is unlikely to be available within a specified/threshold distance of a service destination), etc. In some implementations, the rating 408 can be based at least in part on one or more projected time(s) 408B associated with a transportation service request 401. For instance, a transportation service request 401 may be less favorable to a human driven vehicle based on projected wait/travel time(s) for the proposed route associated with the transportation service request, for example, associated with current and/or projected traffic 408C, road construction, events, and/or the like along the proposed route.

In some implementations, the rating 408 can be based at least in part on one or more area risk profiles 408D associated with a route 408A to be traveled for the transportation service request 401. As described here, risk profiles may be associated with (e.g., obtained, stored, etc.) one or more areas within a geographic region where vehicle services are provided. In some embodiments, the service entity computing system 204 can determine the route risk profiles 408D. The route risk profiles can be calculated, at least in part, by examining area risk profile(s) (e.g., 306A, 306B, 306C, 306D) associated with one or more areas to be traveled along the proposed route 408A for the transportation service request, the duration of time stayed in a certain area, the necessity of traveling through an area, and/or other factors.

In some implementations, the rating 408 can be based at least in part the profile 408F associated with a user associated with a transportation service request. For example, a profile 408F associated with the user requesting the transportation service request may be indicative of a user's experience with and/or favorability with one or more types of autonomous vehicles (e.g., one or more types of service provider autonomous vehicles, one or more types of third party autonomous vehicles, etc.), a user's preference for a human driven vehicle, and/or the like.

In some embodiments, the service entity computing system 204 can determine if an incentive 408E exists for a human driver to accept a transportation service request 400. The incentive 408E can be, but is not limited to, a safer route, a quicker route, a more lucrative route, or any other form of incentive. For example, the service entity computing system may 204 determine that the transportation service request 401 has been submitted during a time period where service compensation is higher than average, providing an incentive for human drivers to service the transportation service request 401.

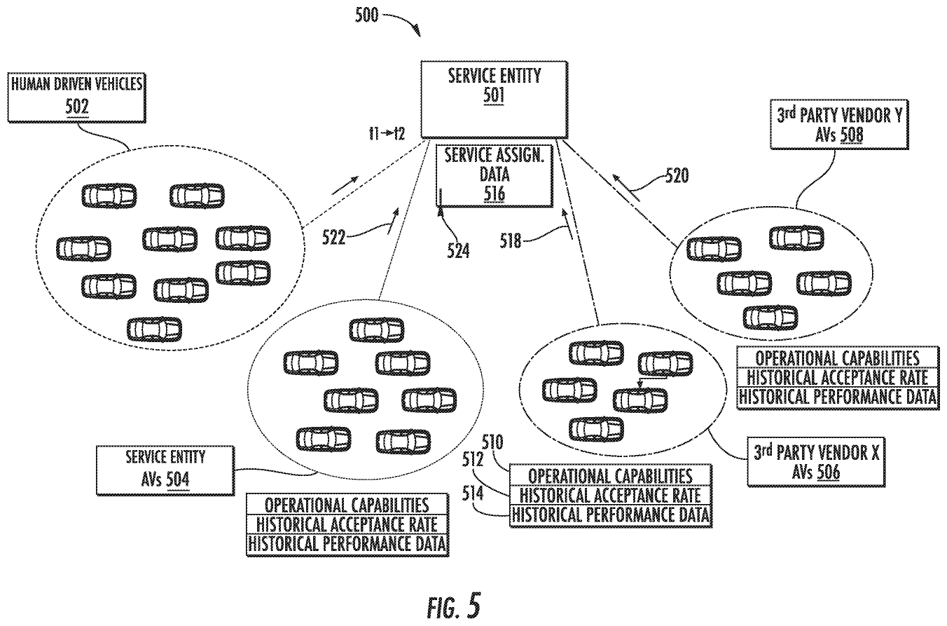

The service entity computing system 204 can determine an availability of a plurality of vehicle service providers for the transportation service request 401. For example, FIG. 5 depicts example ecosystem 500 of vehicle service providers according to example embodiments of the present disclosure. The service entity 501 can utilize a plurality of vehicle service providers including, but not limited to, human driven vehicles 502; service entity/first party autonomous vehicles 504; third party vendor X autonomous vehicles; and third party vendor Y autonomous vehicles.

The service entity computing system 204 can determined which of these vehicle service providers are available for the transportation service request 401. In some implementations, the available vehicle service providers can include vehicle service providers (e.g., one or more human driven vehicles 502, one or more service entity autonomous vehicles 504, one or more third party vendor autonomous vehicles 506/508, etc.) that are currently online with the service entity 504 (e.g., actively engaged, logged in, etc. to a service entity platform/service entity infrastructure 200, etc.) and are not currently engaged in performance of a vehicle service, performance of a maintenance operation, and/or the like. In some implementations, the service entity computing system 204 can determine the availability of the vehicle service provider based at least in part on data provided from the vehicle service provider (e.g., indicating that the vehicle service provider is online/ready to provide a vehicle service). For human driven vehicles 502, this can include, for example, data communicated from a user device associated with the human driver of the vehicle and/or another system. For autonomous vehicles 504, 506, 508 this can include, for example, data communicated directly from the autonomous vehicle and/or from another computing system (e.g., a computing system of vendor X, a computing system of vendor Y, etc.). In some implementations, the service entity computing system 204 can monitor the vehicle service provider (e.g., its progress along a route, when it comes online, etc.) to help determine whether the vehicle service provider is available to service a transportation service request 401. Ultimately, the determined available vehicle service providers can include one or more human driven vehicles, one or more service entity autonomous vehicles, and/or one or more third party autonomous vehicles.

In some implementations, the service entity computing system 204 can determine, based at least in part on the rating 408 (and associated rating parameter(s) 408A-F, whether a human driver would prefer to service a transportation service request 401. If the service entity computing system 204 determines that a human driven vehicle 502 would prefer to service the transportation service request 401, the service provider 500 can assign the transportation service request 401 to one of the plurality of human driven vehicles 502. In some implementations, the human driven vehicles 502 can provide vehicle services exclusively for the service entity. In other implementations, the human driven vehicles 502 can be utilized by both the service entity and by other parties, and/or provided by third parties.

Additionally, or alternatively, the service entity computing system 204 can generate ranking data associated with the available vehicle service providers 504, 506, 508 based at least in part on the data indicative of the transportation service request 401 and the determination as to whether a human driver would prefer to service the transportation service request 401. FIG. 6 depicts example ranking data 600 according to example embodiments of the present disclosure. The ranking data 600 can be indicative of a ranking of at least a subset of the available service providers (e.g., of 502, 504, 506, 508) for servicing the transportation service request 401. As illustrated, the ranking data 600 can include a request identifier 602; a service origin 604; a service destination 606; and ranked available vehicles 608 (e.g., 608A, 608B, 608C, 608D, 608E, and 608F).

In some implementations, the request identifier 602, service origin 604, and service destination 606 can be determined, at least in part, from the transportation service request 401. The service entity computing system 204 can determine this information in a number of ways, including, but not limited to, receiving the information from another component of the service infrastructure 200, appending a vehicle service provider ranking to a transportation service request 401 sent to the service provider 500, or other methods.

In some implementations, the ranked available vehicles 608 depicts a plurality of ranked available vehicles (e.g., 608A, 608B, 608C, 608D, 608E, 608F). The ranked available vehicles 608 can be include a single vehicle service provider or a plurality of vehicle service providers and can include vehicles associated with a single party (e.g., the service entity, one vendor, etc.) or a plurality of parties (e.g., a plurality of vendors, etc.). The list of ranked available vehicles 608 can include human-driven vehicles, service entity autonomous vehicles, and/or third-party autonomous vehicles.

The ranking data 600 associated with one or more of the available vehicle service providers can be generated based at least in part on data associated with the transportation service request 401, the rating associated with the transportation service request 401, and/or other information. In some implementations, the ranking data 600 may be indicative of a ranking (e.g., list, hierarchy, tree, table, and/or other data structure) of at least a subset of the available vehicle service providers in order of highest to lowest preference for servicing the transportation service request. The ranking can list the available service providers (or at least a subset thereof) in order of highest to lowest priority for servicing the transportation service request, lowest priority to highest priority, or any other method of ordering a list.

In some implementations, the ranking data 600 can be indicative of a priority for selecting a respective vehicle service provider for performance of the transportation service request 401 where the priority for selecting one or more autonomous vehicles is inversely proportional to the rating such that the priority associated with the one or more autonomous vehicles is higher for a lower rating. For example, if a transportation service request receives a lower rating (e.g., due to one or more factors as described), the priority for assigning an autonomous vehicle to perform the transportation service request (e.g., the ranking for available autonomous vehicles) will be higher than the priority for assigning a human driven vehicle to the request. Further, in some implementations, as the rating gets lower, the priority for assigning an autonomous vehicle to perform the request gets respectively higher.

In some implementations, generating ranking data associated with one or more available vehicle service providers can be based at least in part on operational capability information 510 (shown in FIG. 5) associated with autonomous vehicle(s) (e.g., service entity autonomous vehicle, third party autonomous vehicles, etc.). The operational capability information may be indicative of the types of autonomous vehicle capabilities (e.g., left turn capability, U-turn capability, autonomous motion functions, weather limitations, geographical range, etc.) and/or operating conditions, routes, and/or the like where one or more autonomous vehicles (e.g., service entity autonomous vehicles, third party vendor autonomous vehicles, etc.) can operate. For example, the third party autonomous vehicles of vendor X may not be able to configured to complete a U-turn, while the third party autonomous vehicles may not be configured to operate in a certain area (e.g., crowded city center, etc.) and/or weather (e.g., snow, rain, etc.).

The service entity computing system 204 can obtain operational capability information 510 associated with the one or more autonomous vehicles (e.g., 506, 508) from one or more sources. For example, in some implementations, operational capability information 510 for one or more autonomous vehicles may be provided by a third party vendor (e.g., vendor X) associated with the autonomous vehicle(s) (e.g., autonomous vehicles owned, managed, etc. by the third party vendor) and such operational capability information 510 for the autonomous vehicle(s) may be stored (e.g., associated with particular autonomous vehicle(s)) by the service entity (e.g., in one or more databases associated with the service entity infrastructure, etc.) and retrieved as needed (e.g., for determining ranking of vehicle service providers, etc.). In some implementations, operational capability information 510 for one or more autonomous vehicles may be generated based on historical tracking and/or observation of one or more autonomous vehicles associated with a particular fleet (e.g., one or more third party vendor fleets, etc.). Such generated operational capability information 510 may be stored (e.g., associated with particular autonomous vehicle(s)) by the service entity (e.g., in one or more databases associated with the service entity infrastructure, etc.) and retrieved as needed (e.g., for determining ranking of vehicle service providers, etc.). In some implementations, the operational capability information 510 can be obtained from the autonomous vehicles.

In some implementations, a priority for each of the respective third party autonomous vehicles 506, 508 to service a transportation service request 401 can be generated based at least in part on the respective operational capability information of each of the third party autonomous vehicles 506, 508. In some implementations, the service entity computing system 204 can determine that one or more of the third party autonomous vehicles 506 are not capable of servicing the transportation service request 401 based at least in part on operational capability information 510 associated with the one or more third party autonomous vehicles 506. In the event that one or more third party autonomous vehicle(s) 506 are not capable of servicing the transportation service request 401, the third party autonomous vehicle(s) 506 that are not capable of servicing the transportation service request 401 can be omitted from the ranking data 600. By way of example, a transportation service that would require a U-turn may not be appropriate for a third party autonomous vehicle 506 that is unable to autonomously perform such a motion function and, thus, such vehicle may be omitted from the ranking data 600.

In some implementations, the operational capability information may be obtained after determining that a human driver would not prefer to service the transportation service request. For example, in the event that the service entity computing system 204 determines that a human driver would not prefer to service a transportation service request 401, the service entity computing system 204 can be configured to determine the availability of an autonomous vehicle service provider(s) (e.g., 206, 210, 212, etc.). For instance, the service entity computing system 204 may determine that the service destination 406 of a transportation service request 401 would take a human driver outside of a preferred range, and therefore would not be preferred by a human driver. In response, the service entity computing system 204 can obtain operational capability information for one or a plurality of autonomous vehicles (e.g., 504, 506, 508).

In some implementations, generating ranking data associated with one or more available vehicle service providers (e.g., 608A, 608B, 608C, 608D, 608E, 608F) may be based in part on historical acceptance rates 512 (shown in FIG. 5) associated with vehicle service providers for a service origin 604, a service destination 606, routes, and/or certain types of vehicle services. For example, the service entity computing system 204 can monitor and/or store data associated with the acceptances or rejections of routes and/or services made by one or more vehicle service providers (and/or a third party fleet). The service entity computing system 204 can use such data to determine acceptance rates for particular routes for a particular vehicle service provider and use the acceptance rates in generating ranking data for a particular vehicle service provider in association with a transportation service request 401. By way of example, if a vehicle service provider has a historically lower acceptance rate for vehicle services associated with particular routes, this lower acceptance rate may cause the vehicle service provider to be ranked lower in the ranking data 600 when those routes (or routes similar thereto) are associated with a transportation service request 401. On the other hand, if a vehicle service provider has a historically high acceptance rate for vehicle services associated with particular routes, this high acceptance rate may cause the vehicle service provider to be ranked higher in the ranking data when those routes are associated with a transportation service request 401.

In some implementations, generating ranking data associated with one or more available vehicle service providers may be based in part on historical performance data 514 associated with performance of vehicle services and/or routes by a vehicle service provider 506. For example, the service entity computing system 204 may monitor and/or store data associated with the performance of vehicle services by one or more vehicle service providers 506 (e.g., third party autonomous vehicles, etc.). The service entity computing system 204 may use the historical performance data in generating ranking data 600 for a particular vehicle service provider 506 in association with a transportation service request 401. In some implementations, the historical performance data 514 may be used in determining particular types of routes, route segments, and/or the like that have been problematic for a particular vehicle service provider 506. By way of example, historical performance data 514 may indicate that a vehicle service provider 506 has had difficulties in performing vehicle services appropriately and/or efficiently for certain types of routes, route segments, route requirements (e.g., left turns, U-turns, etc.), and/or the like. Such historical performance data 514 indicative of problematic routes, route segments, route requirements, etc. for the vehicle service provider 506 may cause the vehicle service provider 506 to be ranked low in the ranking data when those types of routes, route segments, route requirements, etc. are associated with a transportation service request 401.

In some implementations, the ranking data 600 for vehicle service providers may include a subset of the currently available vehicle service providers. One or more available vehicle service providers 502, 504, 506, 508 may be excluded from the ranking data 600 based at least in part on one or more factors indicative of an inability to perform the transportation service request 401, such as the operational capabilities of the vehicle service provider(s) 510, the historical acceptance rates of the vehicle service provider(s) 512, the historical performance data of the vehicle service provider(s) 514, and/or other factors. For instance, the determined available vehicle service providers can include a first autonomous vehicle 506 and a second autonomous vehicle 508. One or both of the first autonomous vehicle 506 or the second autonomous vehicle 508 can be excluded from the ranking data 600 based at least in part on their respective operational capability information. By way of example, the first autonomous vehicle 506 can be associated with a first fleet (e.g., of vendor X) and may be included in the ranking data 600 for vehicle service providers for a transportation service request 401 because the first available autonomous vehicle 506 has one or more operational capabilities that align with the transportation service request 401 (e.g., the ability to autonomously travel in the rain). On the other hand, a second available autonomous vehicle 508 (e.g., associated with a second fleet of vendor Y) may not be included in the generated ranking data 600 based on operational capability information associated with the second autonomous vehicle 508. For example, the second autonomous vehicle 508 may be excluded from the ranking data 600 for vehicle service providers for the transportation service request 401 because the second available autonomous vehicle 508 is unable to perform certain autonomous motion control needed to perform the transportation service request 401 (e.g., autonomous motion in rainy weather). In another example, historical performance data 514 may indicate poor performance along highway routes by the first autonomous vehicle 506 (e.g., a third party autonomous vehicle). For a transportation service request necessitating a route that traverses a highway, the first autonomous vehicle 506 may be excluded from the ranking data 600.

In some implementations, the service entity computing system 204 can adjust one or more rating and/or provider ranking costs, factors, and/or the like, for example, to modify the priorities for assigning vehicle service(s) to different types of vehicle service providers (e.g., human driven vehicles 502, service entity autonomous vehicles 504, third party vendor autonomous vehicles 506/508, etc.). For instance, the service entity computing system 204 may temporarily adjust ranking costs, factors, and/or the like to increase or decrease a preference for assigning particular vehicle services to one of the types of vehicle service providers, such as to adjust current vehicle supply, improve positive experience levels for drivers of human driven vehicles 502 and/or third party vendors X and/or Y.

In some implementations, the service entity computing system 204 can adjust costs, parameters, etc. used in determining ratings 408 and/or ranking data 600 (e.g., ranked available vehicles 608) to facilitate changing needs and/or requirements of the service entity. For instance, the service entity computing system 204 can tune such ratings and/or rankings to adjust the mix of supply for performing vehicle services, for example, to improve driver experience and/or third party vendor experience, to ensure that vehicles are available to service areas as needed, and/or the like.

Returning to FIG. 5, the service entity computing system 204 can determine one or more selected vehicle service providers 502, 504, 506, 508 for the transportation service request based at least in part on the ranking data 600. For instance, the service entity computing system 204 can select the highest ranked available vehicle service provider based on the ranking data 600. In some implementations, the service entity computing system 204 can select several of the higher ranked available vehicle service provider (e.g., including the highest ranked). This selection can be made in order to identify which vehicle service providers are to be requested to perform a vehicle service in accordance with the transportation service request. For example, as described herein, the ranking data 600 can be indicative of a priority for selecting a respective ranked available vehicle 608 for performance of the transportation service request 401. If the first-ranked vehicle service provider is incapable of service the request, the service entity computing system 204 can select the next highest ranked vehicle until a vehicle capable of receiving a vehicle service assignment is found. For example, a third-party autonomous vehicle 506 associated with vendor X may be ranked first in the ranking data 600. If the third-party autonomous vehicle 506 is critically low on fuel and therefore unable to accept a vehicle service assignment, the service entity computing system 204 may identify a human-driven vehicle ranked second.

The service entity computing system 204 can generate vehicle service assignment data 516 associated with performance of the transportation service request 401. For example, the service entity computing system 204 (and/or another system) can generate service assignment data that is indicative of a request (or command) for the vehicle service provider to perform a vehicle service for the transportation service request 401. The service assignment data can be indicative of the service origin 404, service destination 406, route 408A, rating 408, risk profiles 408D, preferences/special assistance of an associated user (e.g., music preferences, climate preferences, wheel chair accessibility, etc.), and/or other information.

The service entity computing system 204 can communicate the vehicle service assignment data 516 to the one or more selected vehicle service providers. The one or more selected vehicle service providers (e.g., human driven vehicles, service entity autonomous vehicles, third party vendor autonomous vehicles, etc.) and allow a selected vehicle service provider to accept or decline the performance of the vehicle service(s) associated with the transportation service request 401. For example, the service entity computing system 204 can communicate the vehicle service assignment data 516 to the selected vehicle service provider(s) to facilitate an acceptance by a selected vehicle service provider before completing assignment of the transportation service request to the selected vehicle service provider. In some implementations, an indication of an acceptance and/or rejection to perform the service(s) can be obtained from a human driver associated with the human driven vehicle (e.g., via an application associated with the service entity, etc.), by a computing system associated with an autonomous vehicle (e.g., onboard an autonomous vehicle, etc.), by a computing system associated with a third party vendor (e.g., a third party vendor operations computing system, etc.), and/or the like. In some implementations, the data communicated in the initial vehicle service assignment data 516 (e.g., offer for assignment data sent prior to receiving an acceptance and completing the assignment to the vehicle, etc.) may vary based on the type of vehicle service provider. For instance, in some implementations, the initial vehicle service assignment data 516 provided to a human driven vehicle 502 may include data that is not provided to an autonomous vehicle 504, 506, 508 or vice versa.

In some implementations, the initial vehicle service assignment data 516 (e.g., offer for assignment data sent prior to receiving an acceptance and completing the assignment to the vehicle, etc.) may be communicated to a first selected vehicle service provider 506 (e.g., selected based on the ranking data associated with the vehicle service providers, etc.) to facilitate an indication of acceptance or rejection of performance of the vehicle service assignment. For example, the service entity computing system 204 may obtain an assignment rejection 518 from the first selected vehicle service provider 506 in response to the communicating the vehicle service assignment data 516. The service entity computing system 204 can determine a next selected vehicle service provider (e.g., 502) for the transportation service request 401 based at least in part on the ranking data 600. For instance, the next selected vehicle service provider can be lower in the ranking data than the first selected vehicle service provider 506 (e.g., the next ranked vehicle service provider). As an example, an autonomous vehicle may be a ranked higher within the ranking data 600 than a human driven vehicle, based at least in part on the rating 400 (e.g., where performance of a vehicle service along a proposed route may be more favorable to performance by an autonomous vehicle than by a human driven vehicle). The service entity computing system 204 can communicate the vehicle service assignment data 516 to the next selected vehicle service provider to facilitate performance of the vehicle service associated with the transportation service request 401.

In some implementations, the service entity computing system 204 can communicate vehicle service assignment data 516 (e.g., associated with a transportation service request 401) to a plurality vehicle service providers concurrently to facilitate an acceptance to perform the service associated with a transportation service request. As an example, the service entity computing system 204 can communicate the vehicle service assignment data 516 to a plurality of autonomous vehicle service providers 504, 506, 508. In response, the service entity computing system 204 can obtain an acceptance 520 to perform a vehicle service associated with the transportation service request 401 from one or more of the plurality of autonomous vehicle service providers 504, 506, 508. In some implementations, the first of the plurality of autonomous vehicle service providers 504, 506, 508 to indicate acceptance is assigned to perform the vehicle service associated with the transportation service request 401. In some implementations, the highest ranked vehicle service provider of the accepting vehicle service providers can be assigned to perform the vehicle service associated with the transportation service request 401. In some implementations, service entity may establish a time window (t1→t2) for receiving an acceptance to perform the service(s) from one or more of the available vehicle service providers after communicating the vehicle service assignment data to the available vehicle service provider(s). During the time window the service entity may establish a preference for one type of vehicle service provider over a different type of vehicle service provider. For example, one or more human driven vehicles 502 can be included in the available vehicle service providers. The service entity computing system 204 can determined that a human driver would prefer to service the transportation service request 401. The service entity computing system 204 can communicate the vehicle service assignment data 516 to the human driver vehicle. The service entity computing system 204 can provide a time window to indicate acceptance of the transportation service request 401 during which an acceptance of the transportation service request 401 from a human driven vehicle will be given preference as the selected vehicle service provider before an acceptance from an autonomous vehicle.

In some implementations, the service entity computing system 204 can obtain feedback data 522 associated with the assignment and performance of vehicle services. The feedback data 522 can be associated with assignment of the transportation service request 401 to the selected vehicle service provider. By way of example, the service entity computing system 204 can obtain and store data associated with what type of vehicle services and/or routes are being accepted and/or rejected by various vehicle service providers 502, 504, 506, 508. In some implementations, the service entity computing system 204 can aggregate and/or analyze such stored feedback data 522 for use in tuning one or more costs used in generating ratings and/or vehicle service provider rankings. For example, the service entity computing system 204 can modify the ranking data 600 based at least in part on the feedback data 522. In some implementations, the service entity computing system 204 can use stored feedback data 522 to provide supply performance tracking. For example, the service entity use supply performance tracking in analyzing the overall performance of vehicle service providers. In some implementations, the service entity computing system 204 can use supply performance tracking in determining ratings 400 for various vehicle service providers 502, 504, 506, 508.

In some implementations, performance incentive(s) 524 can be generated to enhance the likelihood that a vehicle service provider will undertake the vehicle service for a transportation service request 401. By way example, the service entity computing system 204 can determine one or more performance incentives 524 for one or more human driver vehicles and/or one or more autonomous vehicles included in the selected vehicle service providers. The one or more performance incentives 524 designed to encourage acceptance of the transportation service request by at least one of human driver vehicles and/or the autonomous vehicles. This can include an increase in vehicle rating, higher priority for high paying and/or highly rated users, increased compensation, etc. The computing system can communicate data indicative of the one or more performance incentives 525 to the one or more human driven vehicles 502 and/or autonomous vehicles 504, 506, 508 included in the selected vehicle service providers (e.g., to help encourage acceptance).

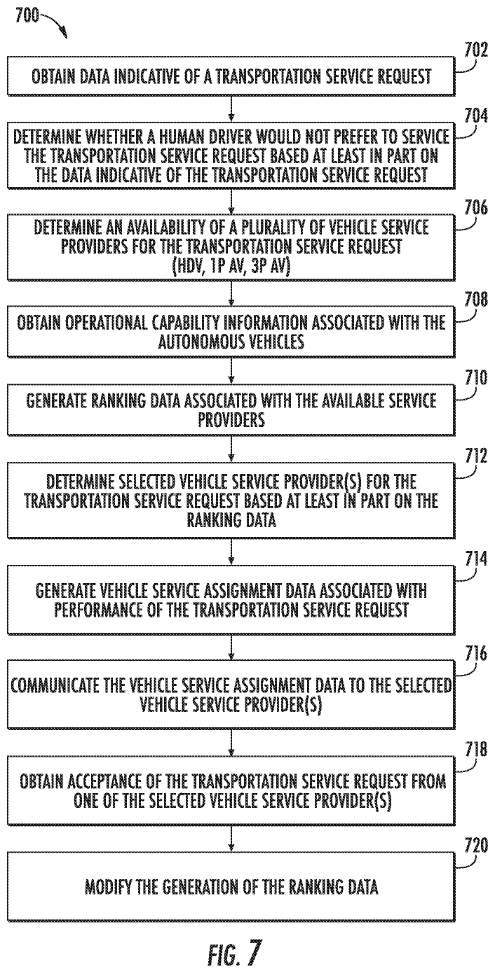

FIG. 7 depicts a flow diagram of an example method 700 for autonomous vehicle deployment and control according to example embodiments of the present disclosure. One or more portion(s) of the method 700 can be implemented by one or more computing devices such as, for example, the computing devices described in FIG. 1, 2, 8, or 9. Moreover, one or more portion(s) of the method 700 can be implemented as an algorithm on the hardware components of the device(s) described herein (e.g., as in FIGS. 1, 2, 8, and 9) to, for example, performing allocation of vehicle service assignments. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At (702), the method 700 can include obtaining data indicative of a transportation service request. For instance, a computing system (e.g., within a system infrastructure 200) can obtain data indicative of a transportation service request 401. The transportation service request 401 can be in the form of a data structure (e.g., list, hierarchy, tree, table, and/or other data structure), and can contain, but is not limited to, a request identifier 402, a service origin 404, a service destination 406, and/or other information. The transportation service request(s) 401 can include multiple rating parameters 408A-F and/or the computing system can determined multiple rating parameters based at least in part on the transportation service request 401. For example, the transportation service request 401 may contain a service origin coordinate (e.g., a latitude and longitude), a service destination coordinate, etc. The rating parameters 408A-F can include data such as, for example, a route 408A associated with the transportation service request 401, one or more wait times associated with the transportation service request(s) 401, a projected travel time 408B associated with the transportation service request 401, a destination 406 associated with the transportation service request 401, one or more area risk profiles (e.g., 306A-D) associated with one or more areas to be traveled for the transportation service request 401; or a profile associated with a user associated with the transportation service request 401, at least one incentive, etc.

At (704), the method 700 can include determining whether a human driver would not prefer to service the transportation service request 401 based at least in part on the data indicative of the transportation service request 401. For instance, the computing system can determine that a human driver would not prefer to service the transportation service request 401 based at least in part on the data indicative of the transportation service request 401. As described herein, the computing system can determine a rating 408 that indicates whether the human driver would prefer to service the transportation service request 401 with a human driven vehicle. The rating 408 can be based at least in part on the rating parameters 408A-F of the transportation service request 401, among other factors to determine the human favorability rating. This rating can indicate the likelihood that a human driver would prefer to service the received transportation service request 401 with a human driven vehicle. The rating can be implemented on a numeric scale, as a binary choice, or any other sort of rating implementation. The computing system can determine that the human driver would not prefer to service the transportation service request 401 based at least in part on the rating

At (706), the method 700 can include determining an availability of a plurality of vehicle service providers for the transportation service request 401. For instance, the computing system can determine an availability of a plurality of vehicle service providers 502, 504, 506, 508 for the transportation service request 401. The plurality of vehicle service providers 502, 504, 506, 508 can include one or more human driven vehicles and one or more autonomous vehicles. This can include a plurality of third-party autonomous vehicles, as described herein. The computing system can query a plurality of vehicle service providers 502, 504, 506, 508 and/or their associated remote computing systems (e.g., vendor computing systems) to determine whether a vehicle service provider 502, 504, 506, 508 is available. To query vehicle service providers 502, 504, 506, 508, the service infrastructure can communicate through a public platform vehicle API 220, communication with vendor platforms (e.g., 210, 212), a private service provider platform vehicle API 232, a vehicle SDK (e.g., 240a, 246a, 246b, etc.), or through other means.

At (708), the method 700 can include obtaining operational capability information associated with the autonomous vehicles. For instance, the computing system can obtain operational capability information 510 associated with the one or more autonomous vehicles of the available vehicle service providers (e.g., 506, 508). Operational capability information 510 can be communicated through a public platform gateway API 220, communication with vendor platforms (e.g., 210, 212), a private service provider platform gateway API 232, a vehicle SDK (e.g., 240a, 246a, 246b, etc.), or through other means. As described herein, the operational capability information may be indicative of the types of autonomous vehicle capabilities (e.g., left turn capability, U-turn capability, autonomous motion functions, etc.) and/or operating conditions, routes, and/or the like where one or more autonomous vehicles (e.g., service entity autonomous vehicles, third party vendor autonomous vehicles, etc.) can operate.

At (710), the method 700 can include generating ranking data associated with the available service providers. For instance, the computing system can generate ranking data 600 associated with the available vehicle service providers 502, 504, 506, 508 based at least in part on the data indicative of the transportation service request 401, the operational capability information 510, and the determination that the human driver would not prefer to address the transportation service request. This can include generating ranking data 600 for each of the available vehicle service providers based at least in part on the data indicative of the transportation service request 401 and a rating 408 associated with the transportation service request 401 (e.g., the rating indicating whether a human driver would prefer to service the transportation service request with a human driven vehicle).

The ranking data 600 can be indicative of a ranking of at least a subset of the available service providers 502, 504, 506, 508 for servicing the transportation service request 401. The ranking data 600 can list the subset of the available service providers in order of highest to lowest priority for servicing the transportation service request 401. The ranking data 600 can indicate a priority for selecting each respective vehicle service provider 502, 504, 506, 508 for servicing the transportation service request 401. The priority associated with the one or more autonomous vehicles can be inversely proportional to the rating such that the priority associated with the one or more autonomous vehicles is higher for a lower rating.

The ranking data 600 can be based at least in part on the operational capability information 510. For example, in some implementations, the computing system can determine a priority for each of the respective third party autonomous vehicles 506, 508 to service the transportation service request 401 based at least in part on the respective operational capability information 510 of the third party autonomous vehicles 506, 508. In some implementations, the computing system can determine that one or more of the third party autonomous vehicles are not capable of servicing the transportation service request 401 based at least in part on operational capability information associated with the one or more third party autonomous vehicles, and the one or more third party autonomous vehicles that are not capable of servicing the transportation service request can be omitted from the ranking. For example, as described herein, the available vehicle service providers can include a first autonomous vehicle 506 and a second autonomous vehicle 508. At least one of the first autonomous vehicle or the second autonomous vehicle may not be included in the ranking data 600 based on operational capability information associated with the first autonomous vehicle 506 or operational capability information associated with the second autonomous vehicle 508.

In some implementations, the computing system can adjust the ranking data. For example, the computing system can adjust the rank of an associated vehicle service provider if the vehicle service provider lacks the operational capabilities required to fulfill the transportation service request. In another example, the computing system can adjust the rank of a vehicle service provider based on historical acceptance and rejection rates for particular routes and/or types of vehicle services. In yet another example, the computing system can adjust the rank of an associated vehicle service provider based at least in part on data associated with the transportation service request 401. For example, the computing system can adjust the rank of a vehicle service provider if the route risk profile 408D includes certain area risk profile(s) 306, if the listed incentive(s) 40E are insufficient, if the request identifier 402 identifies a certain user, and/or for a plurality of other reasons.

At (712), the method 700 can include determining selected vehicle service provide(s) for the transportation service request based at least in part on the ranking data. For instance, the computing system can determine at least one selected vehicle service provider 502, 504, 506, 508 for the transportation service request 401 based at least in part on the ranking data 600. This can include selecting a human driven vehicle 502, a service entity autonomous vehicle 504, and/or a third party autonomous vehicle 506, 508. The selected vehicle service providers can be the highest (or higher) ranked vehicle service providers as indicated in the ranking data 600.

At (714), the method 700 can include generating vehicle service assignment data associated with performance of the transportation service request. For instance, the computing system can generate vehicle service assignment data 516 associated with performance of the transportation service request 401. The vehicle service assignment data 516 may include, but it not limited to, service origin data, service destination data, route data, actions to be performed, way points and other data associated with the transportation service request 401. For example, the computing may generate vehicle service assignment data 516 that indicates that a certain route be taken around one or more areas due to area risk profiles. In another example, the vehicle service assignment data 516 may indicate that a number of waypoints should be traveled. In yet another example, the vehicle assignment data 516 may indicate that the vehicle should stop at a certain waypoint and perform a refueling action before proceeding to the service destination coordinates.

At (716), the method 700 can include communicating the vehicle service assignment data to the selected vehicle service provider(s). For instance, the computing system can communicate the vehicle service assignment data 516 to the at least one selected vehicle service provider to facilitate performance of a vehicle service associated with the transportation service request 401. Such data may be through a public platform vehicle API 220, communication with vendor platforms (e.g., 210, 212), a private service provider platform vehicle API 232, a vehicle SDK (e.g., 240a, 246a, 246b, etc.), or through other means.

In some instances, the service assignment may be rejected. For example, the computing system can obtain an assignment rejection 518 from a first selected vehicle service provider (e.g., an autonomous vehicle) in response to the communicating the vehicle service assignment data 516. The computing system can determine a next selected vehicle service provider (e.g., a human driven vehicle) for the transportation service request 401 based at least in part on the ranking data 600. As described herein, the next selected vehicle service provider can be lower in the ranking than the first selected vehicle service provider. The computing system can communicate the vehicle service assignment data 516 to the next selected vehicle service provider to facilitate performance of the vehicle service associated with the transportation service request 401. In another an example, the computing system can communicate the vehicle service assignment data for a first-ranked third-party autonomous vehicle service provider (e.g., 506). Vendor X can return a rejection. The computing system can then communicate the vehicle service assignment data 516 for a second-ranked third-party autonomous vehicle (e.g., 508), which can be capable of servicing the transportation service request 401.

At (718), the method 700 can include obtaining acceptance of the transportation service request from one of the selected vehicle service provider(s). For instance, the computing system may obtain (e.g., from a vehicle, third party computing system, etc.), in response to communicating the vehicle service assignment data 516 to the one or more selected vehicle service providers, an acceptance 520 to perform the vehicle service associated with the transportation service request 401 from one of the selected vehicle service providers (e.g., directly from a vehicle, indirectly via a third party computing system, etc.). The computing system can assign the performance of the vehicle service associated with the transportation service request 401 to the accepting vehicle service provider. This acceptance and/or assignment can be communicated through a public platform gateway API 220, communication with vendor platforms (e.g., 210, 212), a private service provider platform gateway API 232, a vehicle SDK (e.g., 240a, 246a, 246b, etc.), or through other means. Once an acceptance is obtained, the server infrastructure can confirm the transportation service request acceptance and facilitate initiation of the requested transportation service for a user (e.g., via the backend services of the service entity for supporting the vehicle service).

At (720), the method 700 can include modifying the ranking data. For instance, the computing system can obtain data associated with assignment of the transportation service request 401 to the selected vehicle service provider (e.g., indicating which vehicle service providers are accepting which assignments, etc.). The computing system can store the data associated with assignment of the transportation service request to the selected vehicle service provider with prior data associated with assignment of vehicle services (e.g., data indicative of previous acceptances/rejections, etc. The computing system can modifying the generation of ranking data 600 based in part on the stored data. This can allow the ranking data 600 to reflect the historical preferences, tendencies, etc. of the vehicle service providers and/or their associated fleets.

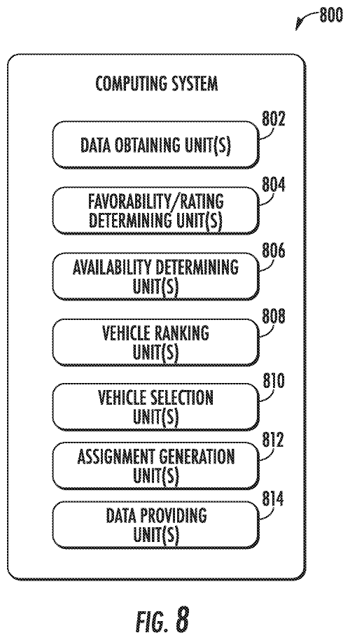

FIG. 8 depicts example units associated with a computing system for performing operations and functions according to example embodiments of the present disclosure. As depicted, FIG. 8 depicts a computing system 800 that can include, but is not limited to, a data obtaining unit(s) 802; a favorability determining unit(s) 804; an availability determining unit(s) 806; a vehicle ranking unit(s) 810; an assignment generation unit(s) 812; and a data providing unit(s) 814. In some implementations one or more units may be implemented separately. In some implementations, one or more units may be included in one or more other units.

In some embodiments, the data obtaining unit(s) 802 can be configured to obtain data, for example, from a user, a vehicle service provider, and/or the like. As an example, the data obtaining unit(s) can be configured to facilitate obtaining transportation service request data from a user. As another example, the data obtaining unit(s) can be configured to facilitate availability data, transportation service assignment acceptance data, and/or the like from a vehicle service provider.

In some embodiments, the favorability determining unit(s) 804 can be configured to determine ratings. For example, the favorability determining unit(s) can be configured to determine ratings for transportation service requests that are indicative of whether a human driver would prefer to service the transportation service request with a human driven vehicle.

In some embodiments, the availability determining unit(s) 806 can be configured to determine the availability of a plurality of vehicle providers (e.g., active in the service entity system but not currently performing a vehicle service, maintenance service, etc.) with regard to performing a transportation service request.

In some embodiments, the vehicle ranking determination unit 808 can be configured to determine ranking data associated with one or more of the available vehicle service providers based at least in part on the transportation service request, ratings, operation capabilities, and/or the like.

In some embodiments, the vehicle selection unit(s) 810 can be configured to determine at least one selected vehicle service provider for the transportation service request. For example, the means can be configured to determine at least one selected vehicle service provider from the available vehicle service providers based at least in part on the ranking data

In some embodiments, the assignment generation unit(s) 812 can be configured to generate vehicle service assignment data associated with the performance of the transportation service request.

In some embodiments, the data providing unit(s) 814 can be configured to provide the vehicle service assignment data to the selected vehicle service provider(s). For example, the means can be configured to provide the vehicle service assignment data to the selected vehicle service provider(s) to obtain an acceptance of performance of the vehicle service associated with the transportation service request.

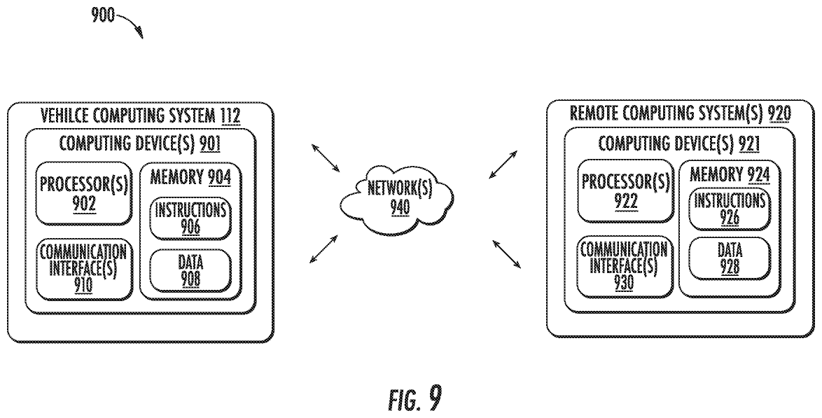

FIG. 900 depicts a block diagram of an example computing system 900 according to example embodiments of the present disclosure. The example system 900 illustrated in FIG. 9 is provided as an example only. The components, systems, connections, and/or other aspects illustrated in FIG. 9 are optional and are provided as examples of what is possible, but not required, to implement the present disclosure. The example system 900 can include the vehicle computing system 112 of the autonomous vehicle 102 and a remote computing system 920 (e.g., operations computing system, other computing system, etc. that is remote from the vehicle 102) that can be communicatively coupled to one another over one or more network(s) 940. The remote computing system 920 can be and/or include the operations computing system 104 and/or remote computing system 106 of FIG. 1. The remote computing system 920 can be associated with a central operations system and/or an entity associated with the vehicle 102 such as, for example, a vehicle owner, vehicle manager, fleet operator, service provider, etc. For instance, the remote computing system 920 can be or otherwise include the remote computing system 104 described herein.

The computing device(s) 901 of the vehicle computing system 112 can include processor(s) 902 and at least one memory 904. The one or more processors 902 can be any suitable processing device (e.g., a processor core, a microprocessor, an ASIC, a FPGA, a controller, a microcontroller, etc.) and can be one processor or a plurality of processors that are operatively connected. The memory 904 can include one or more non-transitory computer-readable storage media, such as RAM, ROM, EEPROM, EPROM, one or more memory devices, flash memory devices, magnetic disks, data registers, etc., and combinations thereof.

The memory 904 can store information that can be accessed by the one or more processors 902. For instance, the memory 904 (e.g., one or more non-transitory computer-readable storage mediums, memory devices) can include computer-readable instructions 906 that can be executed by the one or more processors 902. The instructions 906 can be software written in any suitable programming language or can be implemented in hardware. Additionally, or alternatively, the instructions 906 can be executed in logically and/or virtually separate threads on processor(s) 902.

For example, the memory 904 on-board the vehicle 102 can store instructions 906 that when executed by the one or more processors 902 cause the one or more processors 902 (e.g., in the vehicle computing system 112) to perform operations such as any of the operations and functions of the computing device(s) 901 and/or vehicle computing system 112, any of the operations and functions for which the vehicle computing system 112 is configured, and/or any other operations and functions described herein.

The memory 904 can store data 908 that can be obtained (e.g., received, accessed, written, manipulated, created, generated, etc.) and/or stored. The data 908 can include, for instance, services data (e.g., trip data, route data, user data, etc.), sensor data, map data, perception data, prediction data, motion planning data, object states and/or state data, object motion trajectories, feedback data, fault data, log data, and/or other data/information as described herein. In some implementations, the computing device(s) 901 can obtain data from one or more memories that are remote from the autonomous vehicle 102.

The computing device(s) 901 can also include a communication interface 910 used to communicate with one or more other system(s) (e.g., the remote computing system 920). The communication interface 910 can include any circuits, components, software, etc. for communicating via one or more networks (e.g., network(s) 940). In some implementations, the communication interface 910 can include, for example, one or more of a communications controller, receiver, transceiver, transmitter, port, conductors, software, and/or hardware for communicating data.

The remote computing system 920 can include one or more computing device(s) 921. The computing device(s) 921 can include one or more processors 922 and at least one memory 924. The one or more processors 922 can be any suitable processing device (e.g., a processor core, a microprocessor, an ASIC, a FPGA, a controller, a microcontroller, etc.) and can be one processor or a plurality of processors that are operatively connected. The memory 924 can include one or more tangible, non-transitory computer-readable storage media, such as RAM, ROM, EEPROM, EPROM, one or more memory devices, flash memory devices, data registers, etc., and combinations thereof.

The memory 924 can store information that can be accessed by the one or more processors 922. For instance, the memory 924 (e.g., one or more tangible, non-transitory computer-readable storage media, one or more memory devices, etc.) can include computer-readable instructions 926 that can be executed by the one or more processors 922. The instructions 926 can be software written in any suitable programming language or can be implemented in hardware. Additionally, or alternatively, the instructions 926 can be executed in logically and/or virtually separate threads on processor(s) 922.

For example, the memory 924 can store instructions 926 that when executed by the one or more processors 922 cause the one or more processors 922 to perform operations such as any of the operations and functions of the operations computing system 104, the remote computing system 106, the remote computing system 920 and/or computing device(s) 921 or for which any of these computing systems are configured, as described herein, and/or any other operations and functions described herein.

The memory 924 can store data 928 that can be obtained and/or stored. The data 928 can include, for instance, services data (e.g., trip data, route data, user data etc.), data associated with autonomous vehicles (e.g., vehicle data, maintenance data, ownership data, sensor data, map data, perception data, prediction data, motion planning data, object states and/or state data, object motion trajectories, feedback data, fault data, log data, etc.), third-party entity data, inventory data, scheduling data, log data, attribute data, scenario data, training data, vehicle service provider ranking data, transportation service request rating data, vehicle service provider route history data, vehicle service provider route acceptance data, transportation service request rejection data, transportation service request acceptance data, and/or other data/information as described herein. In some implementations, the computing device(s) 921 can obtain data from one or more memories that are remote from the remote computing system 920.

The computing device(s) 921 can also include a communication interface 930 used to communicate with one or more other system(s) (e.g., the vehicle computing system 112, etc.). The communication interface 930 can include any circuits, components, software, etc. for communicating via one or more networks (e.g., network(s) 940). In some implementations, the communication interface 930 can include, for example, one or more of a communications controller, receiver, transceiver, transmitter, port, conductors, software, and/or hardware for communicating data.

The network(s) 940 can be any type of network or combination of networks that allows for communication between devices. In some embodiments, the network(s) 940 can include one or more of a local area network, wide area network, the Internet, secure network, cellular network, mesh network, peer-to-peer communication link, and/or some combination thereof, and can include any number of wired or wireless links. Communication over the network(s) 1240 can be accomplished, for instance, via a communication interface using any type of protocol, protection scheme, encoding, format, packaging, etc.

Computing tasks discussed herein as being performed at computing device(s) remote from the autonomous vehicle can instead be performed at the autonomous vehicle (e.g., via the vehicle computing system), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implements tasks and/or operations can be performed sequentially or in parallel. Data and instructions can be stored in a single memory device or across multiple memory devices.

Aspects of the disclosure have been described in terms of illustrative embodiments thereof. Numerous other embodiments, modifications, and/or variations within the scope and spirit of the appended claims can occur to persons of ordinary skill in the art from a review of this disclosure. Any and all features in the following claims can be combined and/or rearranged in any way possible.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and/or equivalents to such embodiments. Accordingly, the subject disclosure does not preclude inclusion of such modifications, variations, and/or additions to the present subject matter as would be readily apparent to one of ordinary skill in the art. For instance, features illustrated and/or described as part of one embodiment can be used with another embodiment to yield a still further embodiment. Thus, it is intended that the present disclosure cover such alterations, variations, and/or equivalents.

What is claimed is:

1. A computer-implemented method, the method comprising:
obtaining, by a computing system, data indicative of a transportation service request;
determining, by the computing system, that a human driver would not prefer to service the transportation service request based at least in part on the data indicative of the transportation service request;
determining, by a computing system, an availability of a plurality of vehicle service providers for the transportation service request, wherein the plurality of vehicle service providers comprises one or more human driven vehicles and one or more autonomous vehicles;
obtaining, by the computing system, operational capability information associated with the one or more autonomous vehicles;
generating, by the computing system, ranking data associated with the available vehicle service providers based at least in part on the data indicative of the transportation service request, the operational capability information, and the determination that the human driver would not prefer to address the transportation service request, wherein the ranking data is indicative of a ranking of at least a subset of the available service providers for servicing the transportation service request;
determining, by the computing system, at least one selected vehicle service provider for the transportation service request based at least in part on the ranking data;
generating, by the computing system, vehicle service assignment data associated with performance of the transportation service request; and
communicating, by the computing system, the vehicle service assignment data to the at least one selected vehicle service provider to facilitate performance of a vehicle service associated with the transportation service request.

2. The computer-implemented method of claim 1, wherein determining that the human driver would not prefer to service the transportation service request based at least in part on the data indicative of the transportation service request comprises:
determining, by the computing system, a rating that indicates whether the human driver would prefer to service the transportation service request with a human driven vehicle; and
determining, by the computing system, that the human driver would not prefer to service the transportation service request based at least in part on the rating.

3. The computer-implemented method of claim 2, wherein the ranking indicates a priority for selecting each respective vehicle service provider for servicing the transportation service request, wherein the priority associated with the one or more autonomous vehicles is inversely proportional to the rating such that the priority associated with the one or more autonomous vehicles is higher for a lower rating.

4. The computer-implemented method of claim 2, wherein the ranking lists the subset of the available service providers in order of highest to lowest priority for servicing the transportation service request.

5. The computer-implemented method of claim 1, wherein the one or more autonomous vehicles of the plurality of vehicle service providers comprises a plurality of third party autonomous vehicles.

6. The computer-implemented method of claim 5, wherein generating the ranking data associated with the available vehicle service providers comprises:
determining, by the computing system, a priority for each of the respective third party autonomous vehicles to service the transportation service request based at least in part on the respective operational capability information of the third party autonomous vehicles.

7. The computer-implemented method of claim 5, wherein generating the ranking data associated with the available vehicle service providers comprises:
determining, by the computing system, that one or more of the third party autonomous vehicles are not capable of servicing the transportation service request based at least in part on operational capability information associated with the one or more third party autonomous vehicles, and
wherein the one or more third party autonomous vehicles that are not capable of servicing the transportation service request are omitted from the ranking.

8. The computer-implemented method of claim 2, wherein generating the rating is based at least in part on one or more of:
a route associated with the transportation service request;
one or more wait times associated with the transportation service request;
a projected travel time associated with the transportation service request;
a destination associated with the transportation service request;
one or more area risk profiles associated with one or more areas to be traveled for the transportation service request; or
a profile associated with a user associated with the transportation service request.

9. The computer-implemented method of claim 1, further comprising:
obtaining, by the computing system, an assignment rejection from a first selected vehicle service provider in response to the communicating the vehicle service assignment data;
determining, by the computing system, a next selected vehicle service provider for the transportation service request based at least in part on the ranking data, wherein the next selected vehicle service provider is lower in the ranking than the first selected vehicle service provider; and
communicating, by the computing system, the vehicle service assignment data to the next selected vehicle service provider to facilitate performance of the vehicle service associated with the transportation service request.

10. The computer-implemented method of claim 8, wherein the first selected vehicle service provider is an autonomous vehicle and the next selected service provider is a human driven vehicle.

11. The computer-implemented method of claim 1, wherein the method further comprises:
obtaining, by the computing system, data associated with assignment of the transportation service request to the selected vehicle service provider;
storing, by the computing system, the data associated with assignment of the transportation service request to the selected vehicle service provider with prior data associated with assignment of vehicle services; and
modifying, by the computing system, the generation of the ranking data based at least in part on the stored data.

12. The computer-implemented method of claim 1, wherein the determined available vehicle service providers comprises a first autonomous vehicle and a second autonomous vehicle; and wherein one of the first autonomous vehicle or the second autonomous vehicle is not included in the ranking data based at least in part on operational capability information associated with the first autonomous vehicle or operational capability information associated with the second autonomous vehicle.

13. A computing system, comprising:
one or more processors; and
one or more memories including instructions that, when executed by the one or more processors, cause the one or more processors to perform operations, the operations comprising:
obtaining data indicative of a transportation service request;
determining whether a human driver would prefer to service the transportation request with a human driven vehicle based at least in part on the data indicative of the transportation service request;
determining an availability of a plurality of vehicle service providers for the transportation service request, wherein the plurality of vehicle service providers comprises one or more human driven vehicles and one or more third party autonomous vehicles;
generating ranking data associated with the available vehicle service providers based at least in part on the data indicative of the transportation service request and the determination as to whether the human driver would prefer to service the transportation service request, wherein the ranking data is indicative of a ranking of at least a subset of the available service providers for servicing the transportation service request;
determining one or more selected vehicle service providers for the transportation service request based at least in part on the ranking data;
generating vehicle service assignment data associated with performance of the transportation service request; and
communicating the vehicle service assignment data to the one or more selected vehicle service providers.

14. The computing system of claim 13, wherein the one or more selected vehicle service providers comprise a plurality of autonomous vehicle service providers; and
wherein the operations further comprise obtaining, in response to communicating the vehicle service assignment data to the one or more selected vehicle service providers, an acceptance to perform a vehicle service associated with the transportation service request from one or more of the plurality of autonomous vehicle service providers, wherein the first of the plurality of autonomous vehicle service providers to indicate the acceptance is assigned to perform the vehicle service associated with the transportation service request.

15. The computing system of claim 13, wherein the operations further comprise:
obtaining operational capability information associated with one or more available autonomous vehicles,
wherein generating the ranking data associated with the available vehicle service providers is further based at least in part on the operational capability information associated with the one or more available autonomous vehicles.

16. The computing system of claim 13, wherein, one or more human driven vehicles are included in the available vehicle service providers, wherein it is determined that the human driver would prefer to service the transportation service request, and wherein communicating the vehicle service assignment data to the one or more selected vehicle service providers comprises providing a time window to indicate acceptance of the transportation service request during which an acceptance of the transportation service request from a human driven vehicle will be given preference as the selected vehicle service provider before an acceptance from an autonomous vehicle.

17. The computing system of claim 15, wherein the determined available vehicle service providers comprise a first autonomous vehicle and a second autonomous vehicle; and wherein the second autonomous vehicle is not included in the generated ranking data based on operational capability information associated with the second autonomous vehicle.

18. One or more tangible, non-transitory computer-readable media storing computer-readable instructions that when executed by one or more processors cause the one or more processors to perform operations, the operations comprising:
obtaining data indicative of a transportation service request;
determining an availability of a plurality of vehicle service providers for the transportation service request;
generating ranking data for each of the available vehicle service providers based at least in part on the data indicative of the transportation service request and a rating associated with the transportation service request, the rating indicating whether a human driver would prefer to service the transportation service request with a human driven vehicle;
generating vehicle service assignment data associated with performance of a vehicle service associated with the transportation service request;
determining one or more selected vehicle service providers for the transportation service request based at least in part on the ranking data; and
communicating the vehicle service assignment data to the one or more selected vehicle service providers.

19. The one or more tangible, non-transitory computer-readable media of claim 18, wherein the operations further comprise:
obtaining, in response to communicating the vehicle service assignment data to the one or more selected vehicle service providers, an acceptance to perform the vehicle service associated with the transportation service request from one of the selected vehicle service providers; and
assigning performance of the vehicle service associated with the transportation service request to the accepting vehicle service provider.

20. The one or more tangible, non-transitory computer-readable media of claim 19, wherein the operations further comprise:
determining one or more performance incentives for one or more autonomous vehicles included in the selected vehicle service providers, the one or more performance incentives designed to encourage acceptance to perform a vehicle service for the transportation service request by one of the autonomous vehicles; and
communicating data indicative of the one or more performance incentives to the one or more autonomous vehicles included in the selected vehicle service providers.
